(19) United States
(12) Patent Application Publication
(10) Pub. No.: US 2025/0184666 A1
(43) Pub. Date: Jun. 5, 2025

(54) HEADPHONE DEVICE COUPLED TO WIRELESS EARPHONES, OPERATING METHOD THEREFOR, AND WIRELESS EARPHONES

(71) Applicant: SAMSUNG ELECTRONICS CO., LTD., Suwon-si (KR)

(72) Inventors: Heewoon SHIN, Suwon-si (KR); Jaewon CHOI, Suwon-si (KR)

(73) Assignee: SAMSUNG ELECTRONICS CO., LTD., Suwon-si (KR)

(21) Appl. No.: 19/050,848

(22) Filed: Feb. 11, 2025

Related U.S. Application Data
(63) Continuation of application No. PCT/KR2023/008921, filed on Jun. 27, 2023.

(30) Foreign Application Priority Data
Aug. 22, 2022 (KR) 10-2022-0105051
Sep. 27, 2022 (KR) 10-2022-0122146

(51) Int. Cl. H04R 3/12; H04R 1/10

(52) U.S. Cl. CPC H04R 3/12; H04R 1/1008; H04R 1/1025; H04R 1/105; H04R 1/1066; H04R 2420/07; H04R 2460/01

(57) ABSTRACT

A headphone device includes: a headband; a first headphone unit connected to an end of the headband; a second headphone unit connected to a second end of the headband and electrically connected to the first headphone unit through the headband, where the first headphone unit and the second headphone unit include, respectively: an interface configured to connect to a second interface of an earphone unit capable of wireless communication with a user terminal; a low voltage differential signaling (LVDS) conversion circuit configured to: receive, via the interface, an LVDS signal based on original data corresponding to data received by the earphone unit from the user terminal and data obtained by the earphone unit, and convert the received LVDS signal into the original data; a digital-to-analog converter (DAC) configured to convert audio data included in the original data into an analog signal; and a speaker configured to output sound.

### CROSS-REFERENCE TO RELATED APPLICATIONS

This application is a continuation of International Application No. PCT/KR2023/008921, filed on Jun. 27, 2023, in the Korean Intellectual Property Receiving Office, which is based on and claims priority to Korean Patent Applications No. 10-2022-0105051, filed on Aug. 22, 2022 and No. 10-2022-0122146, filed on Sep. 27, 2022, in the Korean Intellectual Property Office, the disclosures of which are incorporated by reference herein in their entireties.

### BACKGROUND

### 1. Field

The present disclosure relates to a headphone device coupled to wireless earphones and an operating method thereof.

### 2. Description of Related Art

A speaker, headphones, or earphones may be used to output sound. The headphones may be worn by a user by hanging a headband portion on the user's head and completely covering the user's ears. The headphones may primarily block external sound and may reduce the external sound. The headphones may provide a user experience for the user to concentrate on music by blocking the external sound. The headphones may output sound by connecting the headphones to a user terminal by wire or wirelessly.

Earphones are divided into an open type sitting on ears of the user and an in-ear type sitting inside ears of the user and fixed. The in-ear earphones may have better performance in blocking external noise than the open-earphones. The earphones may have better portability than the headphones due to their small sizes. The earphones may output sound by connecting the earphones to a user terminal by wire or wirelessly.

### SUMMARY

Aspects will be set forth in part in the description which follows and, in part, will be apparent from the description, or may be learned by practice of the presented embodiments.

According to an aspect of the disclosure, a headphone device may include: a headband; a first headphone unit connected to a first portion of the headband; and a second headphone unit connected to a second portion of the headband and electrically connected to the first headphone unit through the headband, where the first headphone unit and the second headphone unit include, respectively: an interface configured to connect to a second interface of an earphone unit capable of wireless communication with a user terminal; a low voltage differential signaling (LVDS) conversion circuit configured to: receive, via the interface, an LVDS signal based on first data received from the earphone unit, and convert the received LVDS signal into the first data; a digital-to-analog converter (DAC) configured to convert audio data included in the first data into an analog signal; and a speaker configured to output sound based on the analog signal.

The first headphone unit and the second headphone unit may further include, respectively: an earphone unit coupling portion configured to couple to the earphone unit, where the interface is provided in the earphone unit coupling portion; and an earphone unit cover part configured to cover and support the earphone unit in a state in which the earphone unit coupling portion is coupled to the earphone unit via the interface.

The earphone unit cover part may include: an antenna; and an antenna contact connected to an end of the antenna, where the antenna of the earphone unit cover part is configured to electrically connect, via the antenna contact, to an external contact at an end of a second antenna included in the earphone unit.

The first headphone unit and the second headphone unit may further include, respectively: a cradle unit coupling portion in which the interface is provided and configured to couple to a cradle unit; and a fastening hook configured to prevent the cradle unit separating from the cradle unit coupling portion.

The cradle unit may include: a first surface coupled to the earphone unit; a second surface coupled to the cradle unit coupling portion; and a cradle unit cover part that supports the earphone unit, where, when a shape of the earphone unit is different, a shape of the first surface is configured to correspond thereto, and a shape of the second surface is independent from a shape of the earphone unit.

The cradle unit cover part may include: an antenna; and an antenna contact connected to an end of the antenna, where an external contact connected to an end of a second antenna of the earphone unit is configured to electrically connect to the antenna contact of the cradle unit cover part.

The first headphone unit and the second headphone unit may further include at least one headphone battery, where the first headphone unit and the second headphone unit are respectively configured to connect to the earphone unit via the interface and charge a battery of the earphone unit using the at least one headphone battery.

The first data may be data obtained by processing second data received from the user terminal through wireless communication and third data obtained by a plurality of sensors included in the earphone unit.

The LVDS conversion circuit may be configured to receive the LVDS signal from the earphone unit through a bidirectional channel including a first line and a second line.

The LVDS signal may be a differential signal and is transmitted through the first line and the second line.

The first headphone unit and the second headphone unit may further include, respectively: a capacitor configured to only pass the LVDS signal; and an LC filter configured to separate the LVDS signal and power that the headphone battery transmits or receives.

In a state in which only one of the first headphone unit or the second headphone unit is coupled to the earphone unit, the one of the first headphone unit or the second headphone unit that is coupled to the earphone unit is configured to transmit a portion of a received LVDS signal through the headband to the other of the first headphone unit or the second headphone unit that is not coupled to the earphone unit, where the portion of the received LVDS signal includes data configured to output sound by the other of the first headphone unit or the second headphone unit.

The first headphone unit and the second headphone unit may further include, respectively: a plurality of sensors; a plurality of microphones; and at least one processor configured to: integrate data obtained by the plurality of sensors and the plurality of microphones with the LVDS signal received from the earphone unit, and process the data and the received LVDS signal.

According to an aspect of the disclosure, wireless earphones may include: a first earphone unit configured to couple to a first headphone unit connected to a portion of a headband of a headphone device; and a second earphone unit configured to couple to a second headphone unit connected to a second portion of the headband electrically connected to the first headphone unit, where the first earphone unit and the second earphone unit include, respectively: a battery; an antenna configured to wirelessly receive data from a user terminal;
a processor configured to generate first data based on second data received from the user terminal and third data collected by a plurality of sensors; an interface configured to connect to the headphone unit of the headphone device; and a low voltage differential signaling (LVDS) conversion circuit configured to convert the first data into an LVDS signal via the interface, and transmit the converted LVDS signal to the headphone unit of the headphone device.

According to an aspect of the disclosure, a method of operating a headphone device may include: determining whether a first headphone unit connected to a portion of a headband and a second headphone unit connected to a second portion of the headband are connected to an earphone unit capable of wireless communication with a user terminal via an interface; receiving, by a low voltage differential signaling (LVDS) conversion circuit respectively included in the first headphone unit and the second headphone unit, an LVDS signal based on first data received from the earphone unit; converting the received LVDS signal into the first data by the LVDS conversion circuit; converting audio data included in the first data into an analog signal by a digital-to-analog converter (DAC); and outputting sound, based on the analog signal, by a speaker.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment according to embodiments;

FIG. 2 is a block diagram illustrating an audio module according to various embodiments;

FIG. 3 is a diagram schematically illustrating headphones coupled to an earphone unit according to an embodiment of the present disclosure;

FIG. 4 is a diagram illustrating an earphone unit coupling portion and an earphone unit cover part of headphones coupled to an earphone unit according to an embodiment of the present disclosure;

FIG. 5 is a cradle unit coupled with an earphone unit and a stand unit coupling portion of headphones according to an embodiment of the present disclosure;

FIG. 6A and FIG. 6B are diagrams illustrating an earphone unit and an earphone unit cover part according to an embodiment of the present disclosure;

FIG. 7A and FIG. 7B are diagrams illustrating an earphone unit and an earphone unit cover part including an antenna according to an embodiment of the present disclosure;

FIG. 8A and FIG. 8B are diagrams illustrating an earphone unit and antenna extension of headphones according to an embodiment of the present disclosure;

FIG. 9 is a block diagram illustrating a flow of data and power when an earphone unit processes an operation according to an embodiment of the present disclosure;

FIG. 10 is a flowchart illustrating operations of an earphone unit and headphones when the earphone unit processes an operation according to an embodiment of the present disclosure;

FIG. 11A and FIG. 11B are diagrams illustrating communication between headphones and an earphone unit according to an embodiment of the present disclosure;

FIG. 12A and FIG. 12B are diagrams illustrating a signal according to communication between headphones and an earphone unit according to an embodiment of the present disclosure;

FIG. 13 is a block diagram illustrating headphones that include a plurality of sensors and are coupled to an earphone unit according to an embodiment of the present disclosure;

FIG. 14 is a flowchart illustrating headphones that include a plurality of sensors and are coupled to an earphone unit according to an embodiment of the present disclosure;

FIG. 15 is a block diagram illustrating headphones that include a plurality of Bluetooth integrated circuits (ICs) and are coupled to an earphone unit according to an embodiment of the present disclosure;

FIG. 16 is a block diagram illustrating headphones used alone and connected to a user terminal by wire according to an embodiment of the present disclosure;

FIG. 17 is a block diagram illustrating headphones connected to a user terminal by wire and used according to an embodiment of the present disclosure; and

FIG. 18 is a flowchart illustrating an operating method of a headphone device according to an embodiment of the present disclosure.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

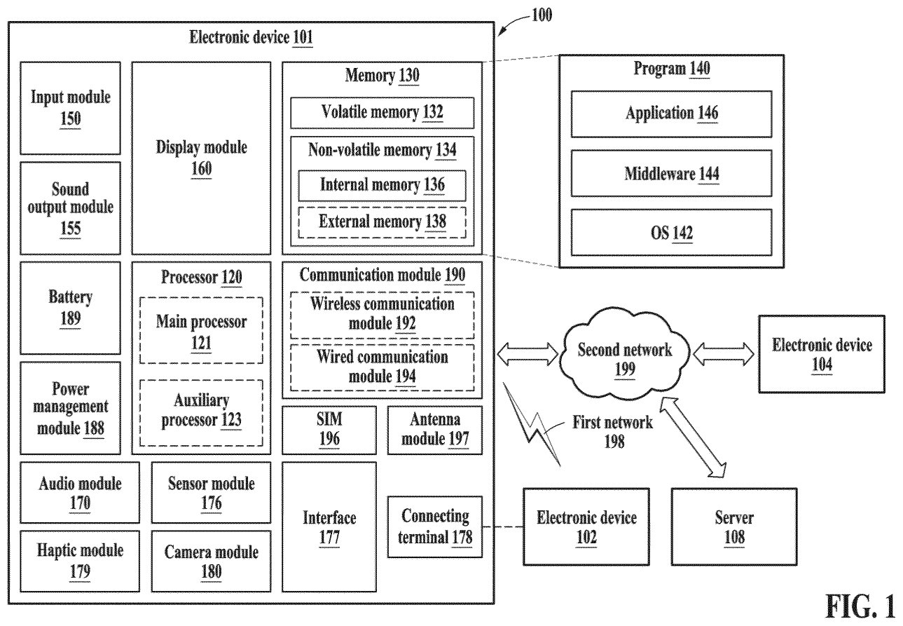

FIG. 1 is a block diagram illustrating an electronic device 101 in a network environment 100 according to various example embodiments. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to one embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one (e.g., the connecting terminal 178) of the above components may be omitted from the electronic device 101, or one or more other components may be added to the electronic device 101. In some embodiments, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to one embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to one embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to one embodiment, the auxiliary processor 123 (e.g., an ISP or a CP) may be implemented as a portion of another component (e.g., the camera module 180 or the communication module 190) that is functionally related to the auxiliary processor 123. According to one embodiment, the auxiliary processor 123 (e.g., an NPU) may include a hardware structure specified for artificial intelligence (AI) model processing. An AI model may be generated through machine learning. Such learning may be performed by, for example, the electronic device 101 in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure.

The memory 130 may store various data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used to receive an incoming call. According to one embodiment, the receiver may be implemented separately from the speaker or as a part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to one embodiment, the display module 160 may include a touch sensor adapted to sense a touch, or a pressure sensor adapted to measure an intensity of a force incurred by the touch.

The audio module 170 may convert a sound into an electrical signal or vice versa. According to one embodiment, the audio module 170 may obtain the sound via the input module 150 or output the sound via the sound output module 155 or an external electronic device (e.g., an electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101, and generate an electric signal or data value corresponding to the detected state. According to one embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to one embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to one embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus which may be recognized by a user via his or her tactile sensation or kinesthetic sensation. According to one embodiment, the haptic module 179 may include, for example, a motor, a piezoelectric element, or an electric stimulator.

The camera module 180 may capture a still image and moving images. According to one embodiment, the camera module 180 may include one or more lenses, image sensors, ISPs, or flashes.

The power management module 188 may manage power supplied to the electronic device 101. According to one embodiment, the power management module 188 may be implemented as, for example, at least a part of a power management integrated circuit (PMIC).

The battery 189 may supply power to at least one component of the electronic device 101. According to one embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., an AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mm Wave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. According to one embodiment, the antenna module 197 may include an antenna including a radiating element including a conductive material or a conductive pattern formed in or on a substrate (e.g., a printed circuit board (PCB)). According to one embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to one embodiment, another component (e.g., a radio frequency integrated circuit (RFIC)) other than the radiating element may be additionally formed as a part of the antenna module 197.

According to one embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to one embodiment, commands or data may be transmitted or received between the electronic device 101 and the external electronic device 104 via the server 108 coupled with the second network 199. Each of the external electronic devices 102 and 104 may be a device of the same type as or a different type from the electronic device 101. According to one embodiment, all or some of operations to be executed by the electronic device 101 may be executed at one or more external electronic devices (e.g., the external electronic devices 102 and 104, and the server 108). For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the result, with or without further processing the result, as at least part of a response to the request. To this end, cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to one embodiment, the external electronic device 104 or the server 108 may be included in the second network 199. The electronic device 101 may be applied to intelligent services (e.g., a smart home, a smart city, a smart car, or healthcare) based on 5G communication technology or IoT-related technology.

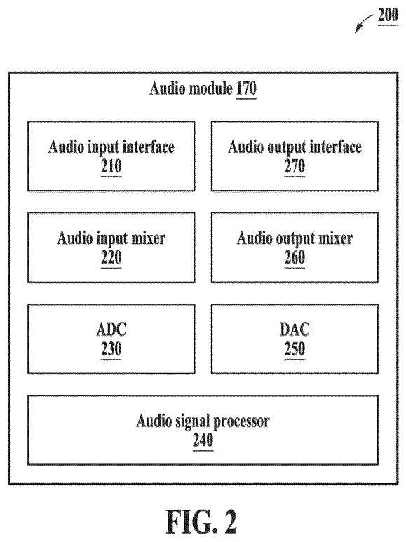

FIG. 2 is a block diagram 200 of an audio module 170 according to various embodiments. Referring to FIG. 2, the audio module 170 may include an audio input interface 210, an audio input mixer 220, an analog-to-digital converter (ADC) 230, an audio signal processor 240, a digital-to-analog converter (DAC) 250, an audio output mixer 260, or an audio output interface 270.

The audio input interface 210 may receive an audio signal corresponding to a sound obtained from the outside of the electronic device 101 via a microphone (e.g., a dynamic microphone, a condenser microphone, or a piezo microphone) that is configured as part of the input module 150 or separately from the electronic device 101. For example, if an audio signal is obtained from the external electronic device 102 (e.g., a headset or a microphone), the audio input interface 210 may be connected with the external electronic device 102 directly via the connecting terminal 178, or wirelessly (e.g., Bluetooth™ communication) via the wireless communication module 192 to receive the audio signal. According to one embodiment, the audio input interface 210 may receive a control signal (e.g., a volume adjustment signal received via an input button) related to the audio signal obtained from the external electronic device 102. The audio input interface 210 may include a plurality of audio input channels and may receive a different audio signal via a corresponding one of the plurality of audio input channels, respectively. According to one embodiment, additionally or alternatively, the audio input interface 210 may receive an audio signal from another component (e.g., the processor 120 or the memory 130) of the electronic device 101.

The audio input mixer 220 may synthesize a plurality of input audio signals into at least one audio signal. For example, according to one embodiment, the audio input mixer 220 may synthesize a plurality of analog audio signals input via the audio input interface 210 into at least one analog audio signal.

The ADC 230 may convert an analog audio signal into a digital audio signal. For example, according to one embodiment, the ADC 230 may convert an analog audio signal received via the audio input interface 210 or, additionally or alternatively, an analog audio signal synthesized via the audio input mixer 220 into a digital audio signal.

The audio signal processor 240 may perform various processing on a digital audio signal received via the ADC 230 or a digital audio signal received from another component of the electronic device 101. For example, according to one embodiment, the audio signal processor 240 may perform changing a sampling rate, applying one or more filters, interpolation processing, amplifying or attenuating a whole or partial frequency bandwidth, noise processing (e.g., attenuating noise or echoes), changing channels (e.g., switching between mono and stereo), mixing, or extracting a specified signal for one or more digital audio signals. According to one embodiment, one or more functions of the audio signal processor 240 may be implemented in the form of an equalizer.

The DAC 250 may convert a digital audio signal into an analog audio signal. For example, according to one embodiment, the DAC 250 may convert a digital audio signal processed by the audio signal processor 240 or a digital audio signal obtained from another component (e.g., the processor 120 or the memory 130) of the electronic device 101 into an analog audio signal.

The audio output mixer 260 may synthesize a plurality of audio signals, which are to be output, into at least one audio signal. For example, according to one embodiment, the audio output mixer 260 may synthesize an analog audio signal converted by the DAC 250 and another analog audio signal (e.g., an analog audio signal received via the audio input interface 210) into at least one analog audio signal.

The audio output interface 270 may output an analog audio signal converted by the DAC 250 or, additionally or alternatively, an analog audio signal synthesized by the audio output mixer 260 to the outside of the electronic device 101 via the sound output module 155. The sound output module 155 may include, for example, a speaker, such as a dynamic driver or a balanced armature driver, or a receiver. According to an embodiment, the sound output module 155 may include a plurality of speakers. In such a case, the audio output interface 270 may output audio signals having a plurality of different channels (e.g., stereo channels or 5.1 channels) via at least some of the plurality of speakers. According to one embodiment, the audio output interface 270 may be connected to the external electronic device 102 (e.g., an external speaker or a headset) directly via the connecting terminal 178 or wirelessly via the wireless communication module 192 to output an audio signal.

According to one embodiment, the audio module 170 may generate, without separately including the audio input mixer 220 or the audio output mixer 260, at least one digital audio signal by synthesizing a plurality of digital audio signals using at least one function of the audio signal processor 240.

According to one embodiment, the audio module 170 may include an audio amplifier (e.g., a speaker amplifying circuit) that is capable of amplifying an analog audio signal input via the audio input interface 210 or an audio signal that is to be output via the audio output interface 270. According to one embodiment, the audio amplifier may be configured as a module separate from the audio module 170.

The electronic device according to some embodiments may be one of various types of electronic devices. The electronic device may include, for example, a portable communication device (e.g., a smartphone), a computer device, a portable multimedia device, a portable medical device, a camera, a wearable device, or a home appliance device. According to one embodiment of the disclosure, the electronic device is not limited to those described above.

It should be appreciated that embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to one embodiment, the module may be implemented in a form of an application-specific integrated circuit (ASIC).

Embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to some embodiments, each component (e.g., a module or a program) of the above-described components may include a single entity or multiple entities, and some of the multiple entities may be separately disposed in different components. According to some embodiments, one or more of the above-described components may be omitted, or one or more other components may be added. Alternatively or additionally, a plurality of components (e.g., modules or programs) may be integrated into a single component. In such a case, according to some embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

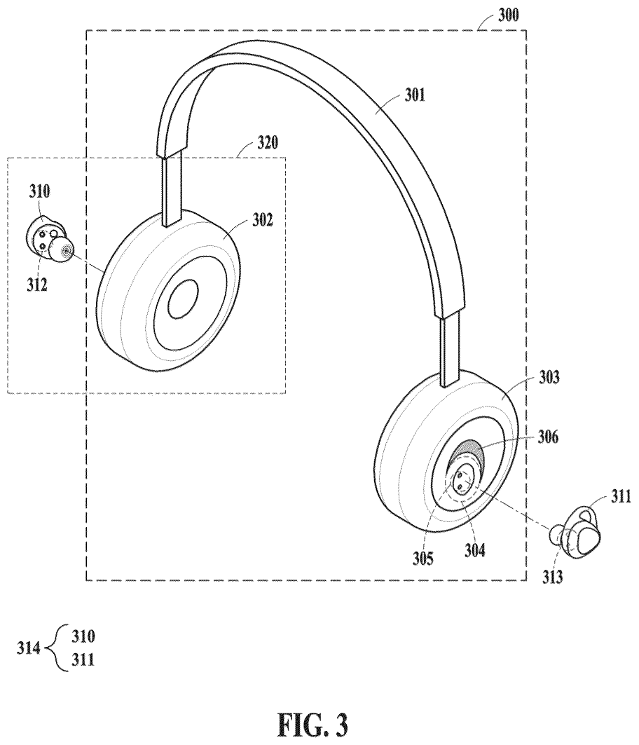

FIG. 3 is a diagram schematically illustrating a headphone device coupled to an earphone unit according to an embodiment of the present disclosure.

Referring to FIG. 3, a headphone device 300 and earphones 314 are illustrated.

The headphone device 300 and the earphones 314 may be an example of the electronic device 101 and the electronic device 102 of FIG. 1.

The headphone device 300 may include a headband 301 worn on a head of a user. The headphone device 300 may include a first headphone unit 302 including a first headphone housing connected to an end of the headband 301 and in close contact with an ear of the user. The first headphone unit 302 may include various components for performing operations described below in addition to the first headphone housing. For example, the first headphone unit may include a speaker for outputting sound. In some cases, the first headphone unit may include an antenna and/or a communication module for communicating with a user terminal.

The headphone device 300 may include a second headphone unit 303 including a second headphone housing connected to the other end of the headband 301, electrically connected to the first headphone unit 302 via a conducting wire, and in close contact with the opposite side ear of the user. A conducting wire may be included in the headband 301 and the first headphone unit 302 and the second headphone unit 303 may be electrically connected via the conducting wire. For example, the conducting wire may be two lines.

The first headphone unit 302 connected to a first portion of the headband 301. The second headphone unit 303 connected to a second portion of the headband 301.

The first headphone unit 302 may be coupled to the first earphone unit 310. The first headphone unit 302 may include an earphone unit coupling portion that may be coupled to the first earphone unit 310. In addition, when the first headphone unit 302 is coupled to the first earphone unit 310, the first headphone unit 302 may include an earphone unit cover part to support the first earphone unit 310.

Referring to the second headphone unit 303, the earphone unit coupling portion 304, which may be coupled to the second earphone unit 311, may be included. The earphone unit coupling portion 304 may be a space that may be coupled to the second earphone unit 311. The earphone unit coupling portion 304 may include a magnet disposed in a same arrangement as an internal magnet arrangement of the second earphone unit 311 but having a different polarity to be strongly and accurately coupled to the second earphone unit 311. When the second earphone unit 311 is positioned near the earphone unit coupling portion 304, the second earphone unit 311 may be easily coupled to the earphone unit coupling portion 304 by the magnet and may not be easily removed. In addition, the earphone unit coupling portion 304 may be formed in a structure that is similar to an earphone unit seating structure of a charging cradle for charging the second earphone unit 311 to easily couple to the second earphone unit 311. The earphone unit seating structure of the charging cradle may be a structure corresponding to a shape of the earphone unit.

According to an embodiment, an interface 305 that may be coupled to the second earphone unit 311 may be disposed in the earphone unit coupling portion 304. The interface 305 may include a pogo pin including two or more electrical contacts.

The interface 305 may be an example of the connecting terminal 178 of FIG. 1.

When the second headphone unit 303 is coupled to the second earphone unit 311, the interface 305 of the headphone device 300 and an interface 313 of the second earphone unit 311 may be electrically connected to each other to transmit and receive data and/or power. For example, the two or more electrical contacts may be a pogo pin. However, the example is not limited thereto and the two or more electrical contacts may include any electrically connectable contact. In addition, the second headphone unit 303 may include an earphone unit cover part 306 to support the second earphone unit 311 when the second earphone unit 311 is coupled.

The earphone unit coupling portion and the earphone unit cover part of the first headphone unit 302 are not shown in FIG. 3, and thus, descriptions thereof are omitted. However, the descriptions of the earphone unit coupling portion 304 and the earphone unit cover part 306 of the second headphone unit 303 are applicable to the earphone unit coupling portion and the earphone unit cover part of the first headphone unit 302.

The earphones 314 may include a first earphone unit 310 coupled to the first headphone unit 302. The earphones 314 may include a second earphone unit 311 coupled to the second headphone unit 303. For example, the earphone unit may be an in-ear type, but is not limited thereto, and may be an open type. The first earphone unit 310 and the second earphone unit 311 may include interfaces 312 and 313 that may transmit and receive data and/or power by being coupled to the headphone unit. The interfaces 312 and 313 may include a pogo pin including two or more electrical contacts. However, the interfaces 312 and 313 are not limited thereto and may include any electrically connectable contact.

Hereinafter, the coupling of headphones to earphones using the first headphone unit 302 and the first earphone unit 310 is described.

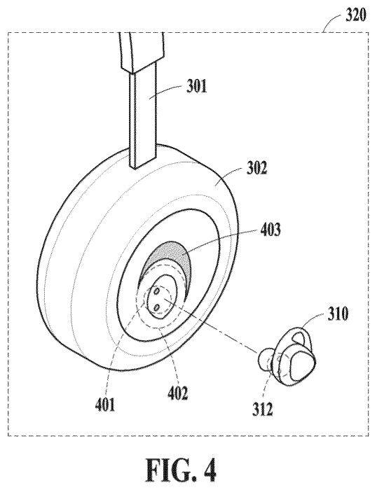

FIG. 4 is a diagram illustrating an earphone unit coupling portion and an earphone unit cover part of headphones coupled to an earphone unit according to an embodiment of the present disclosure.

Referring to FIG. 4, an enlarged portion 320 of the first headphone unit 302 and the first earphone unit 310 is illustrated. Referring to the portion 320, a headphone device (e.g., the electronic device 101 of FIG. 1 and the headphone device 300 of FIG. 3) including the headband 301 and the first headphone unit 302 connected to an end of the headband 301 is illustrated.

The first headphone unit 302 may include an earphone unit coupling portion 402 (e.g., the earphone unit coupling portion 304 of FIG. 3) and an earphone unit cover part 403 (e.g., the earphone unit cover part 306).

The earphone unit coupling portion 402 may be a space having a concave shape in an inner direction of the first headphone unit 302 to be coupled to the first earphone unit 310. The earphone unit coupling portion 402 may be formed in a shape similar to an inner shape of a charging cradle corresponding to the shape of the first earphone unit 310 to be strongly coupled to the first earphone unit 310. In addition, the earphone unit coupling portion 402 may include a magnet disposed in a same arrangement as the internal magnet of the first earphone unit 310 and having an opposite polarity from the internal magnet of the first earphone unit 310 to be strongly coupled to the first earphone unit 310. In other words, when coupling to the first earphone unit 310, the internal magnet of the earphone unit coupling portion 402 may be disposed in a same position as the magnet in the first earphone unit 310 but may have an opposite polarity.

According to an embodiment, the earphone unit coupling portion 402 may include an interface 401 (e.g., the interface 305 of FIG. 3) connected to the electrical contact of the earphone unit that may wirelessly communicate with a user terminal. The interface 401 may be an example of the connecting terminal 178 of FIG. 1. The first headphone unit 302 may be connected to the interface 312 of the first earphone unit 310 via the interface 401. For example, the interface 401 may be a pogo pin but is not limited thereto and may include any electrically connectable contact. The headphone device may transmit and receive data and/or power to or from the first earphone unit via the interface 401. Specifically, a headphone unit (e.g., the first headphone unit 302 and the second headphone unit 303 of FIG. 3) included in the headphone device may transmit and receive data and/or power via an interface (e.g., the interface 305 of FIG. 3 and the interface 401 of FIG. 4). For example, the first headphone unit 302 may transmit and receive data and/or power to or from the first earphone unit 310 via the interface 401. For example, the first headphone unit 302 may receive audio data from the first earphone unit 310 via the interface 401. For example, the first headphone unit 302 may transmit power from the first earphone unit 310 via the interface 401.

The earphone unit cover part 403 may support the first earphone unit 310 to prevent the first earphone unit 310 from being easily removed when the first earphone unit 310 and the first headphone unit 302 are coupled to each other. The earphone unit cover part 403 may be designed in a structure in which a direction toward the earphone unit is cut to prevent occluding the antenna of the first earphone unit 310. The earphone unit cover part 403 may be a sliding structure that slides in the direction of the first earphone unit 310 to cover and support the earphone unit. The earphone unit cover part 403 may be a lid structure in which a hinge is attached to one end thereof to cover and support the first earphone unit 310.

Although the descriptions are provided based on the first headphone unit 302 and the first earphone unit 310, the descriptions of the first headphone unit 302 and the description of the first earphone unit 310 may apply to a second headphone unit (e.g., the second headphone unit 303 of FIG. 3) and a second earphone unit (e.g., the second earphone unit 311 of FIG. 3).

Hereinafter, a method of coupling an earphone unit (e.g., the first earphone unit 310 or the second earphone unit 311) to a headphone unit (e.g., the first headphone unit 302 or the second headphone unit 303) via a cradle unit rather than directly coupling.

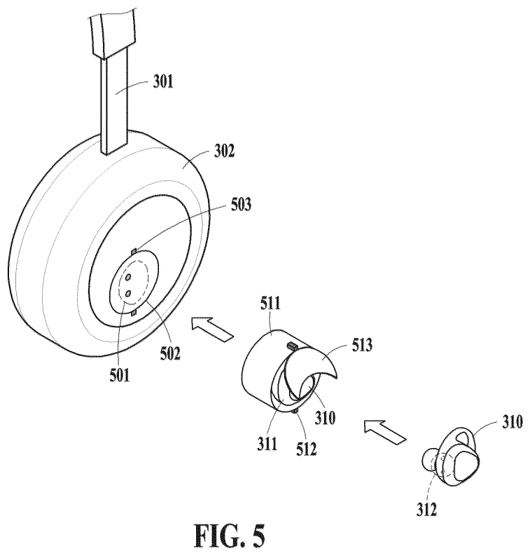

FIG. 5 is a cradle unit coupled with an earphone unit and a stand unit coupling portion of headphones according to an embodiment of the present disclosure.

Referring to FIG. 5, a headphone device (e.g., the electronic device 101 of FIG. 1 and the headphone device 300 of FIG. 3), a cradle unit 511, and the first earphone unit 310 are illustrated. Referring to FIG. 5, the headband 301 and the first headphone unit 302 are illustrated.

The first headphone unit 302 according to an embodiment may include a cradle unit coupling portion 502 coupled to the cradle unit 511 and a hook 503 for fixing the cradle unit. The first headphone unit 302 may be directly coupled to the first earphone unit 310 as shown in FIG. 4 but may be indirectly coupled to the first earphone unit 310 via the cradle unit 511. The cradle unit coupling portion 502 may include an interface 501 (e.g., the interface 305 of FIG. 3 and the interface 401 of FIG. 4) for communicating with the earphone unit. For example, the interface 501 may be a pogo pin but is not limited thereto and may include any electrically connectable contact. The cradle unit coupling portion 502 may have a shape that is concave toward the inside of the headphone to be coupled to the cradle unit 511.

The cradle unit 511 may include a first surface coupled to the first earphone unit 310 and a second surface coupled to the cradle unit coupling portion 502. The first surface may have a shape corresponding to the shape of an earphone unit (e.g., the first earphone unit 310) coupled to the cradle unit 511. The first surface may have a same shape as an inner shape of a charging cradle of the earphone unit corresponding to the shape of the earphone unit to be easily coupled to the earphone unit. The first surface may include a magnet in a same arrangement as the inside of the charging cradle of the earphone unit to be easily coupled to the earphone unit. The magnet inside the charging cradle may be disposed in the same position as the magnet in the earphone unit and may have a different polarity. In other words, the first surface may have a shape corresponding to the shape of the earphone unit. The first surface may include a magnet disposed in the same position as the magnet disposed in the earphone unit and having a different polarity to be easily coupled to the earphone unit.

On the other hand, the second surface of the cradle unit 511 coupled to the cradle unit coupling portion 502 may be identically designed regardless of the shape of the earphone. The second surface may have a shape corresponding to the shape of the cradle unit coupling portion 502 regardless of the shape of the earphone. Similarly, the cradle unit coupling portion 502 may be identically designed regardless of the shape of the earphone unit. In other words, only the first surface of the cradle unit 511 may be differently designed depending on the shape of the earphone unit, and the second surface of the cradle unit 511 and the cradle unit coupling portion 502 may be identically designed. By changing the cradle unit 511 regardless of the shape of the earphone unit, the headphone device may be compatible with an arbitrary earphone unit.

The first surface of the cradle unit 511 according to an embodiment may include an interface to communicate with the earphone unit. In addition, the second surface of the cradle unit 511 may include an interface to communicate with the headphone device. The earphone unit and the headphone device may transmit and receive data and/or power via the interface included in the cradle unit 511. The interface may include a pogo pin including two-pin or more electrical contacts. For example, when the first earphone unit 310 is coupled to the first headphone unit 302 via the cradle unit 511, the interface 312 of the first earphone unit 310 may be connected to the interface included in the first surface of the cradle unit 511. The interface 501 of the first headphone unit 302 may be connected to the interface included in the second surface of the cradle unit 511. Ultimately, audio data may be transmitted to the interface 501 of the headphone unit from the interface 312 of the first earphone unit 310 via respective interfaces included in the first surface and the second surface of the cradle unit 511.

The cradle unit 511 may include a cradle unit cover part 513 to support the earphone unit. The cradle unit cover part 513 may be a structure connected to the cradle unit 511 as a hinge is attached to one end thereof and configured to cover and support the first earphone unit 310 as a lid. The cradle unit cover part 510 may be a sliding type that slides in the direction of the first earphone unit 310 and covers and supports a portion of the first earphone unit 310.

The cradle unit 511 may include a hook 512 to fix the coupling of the cradle unit 511 to the first headphone unit 302. The first headphone unit 302 may include a hook 503 to fix the coupling to the cradle unit 511. When the first headphone unit 302 is coupled to the cradle unit 511, the hook 512 of the cradle unit 511 may be engaged and fixed to the hook 503 of the first headphone unit 302.

Hereinafter, an earphone unit cover part (e.g., the earphone unit cover part 306 of FIG. 3 and the earphone unit cover part 403 of FIG. 4) and an earphone unit (e.g., the first earphone unit 310 or the second earphone unit 311) supported by the earphone unit cover part are described.

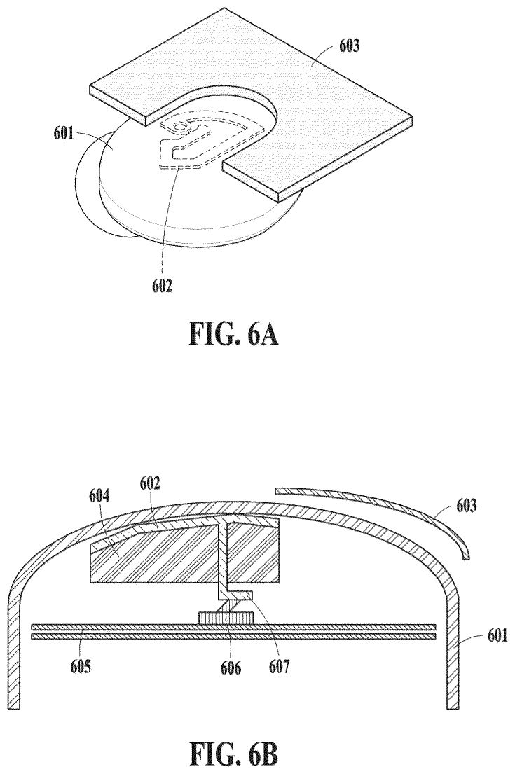

FIGS. 6A and 6B are diagrams illustrating an earphone unit and a unit supporting the earphone unit according to an embodiment of the present disclosure.

FIG. 6A is a diagram illustrating the coupling of an earphone unit 601 to a unit 603 supporting the earphone unit 601. FIG. 6B is a side view of an internal structure to describe the coupling of the earphone unit 601 to the unit 603 supporting the earphone unit 601.

The unit 603 supporting the earphone unit 601 may be an earphone unit cover part (e.g., the earphone unit cover part 306 of FIG. 3 and the earphone unit cover part 403 of FIG. 4) and a cradle unit cover part (e.g., the cradle unit cover part 513 of FIG. 5). Hereinafter, the description is provided based on the earphone unit cover part for ease of description, but the description thereof may apply to the cradle unit cover part.

Referring to FIG. 6, an earphone unit 601 and an earphone unit cover part 603 (e.g., the earphone unit cover part 306 of FIG. 3 and the earphone unit cover part 403 of FIG. 4) are illustrated.

The earphone unit 601 may be a first earphone unit (e.g., the first earphone unit 310 of FIG. 3) or a second earphone unit (e.g., the second earphone unit 311 of FIG. 3). The earphone unit 601 may include an antenna 602 to wirelessly communicate with a user terminal. The earphone unit 601 may include the antenna 602 for wireless communication.

When the earphone unit cover part 603 covers a portion in which the antenna 602 of the earphone unit 601 is built, interference may occur in the antenna and the wireless communication efficiency may decrease. The earphone unit cover part 603 may be cut in a portion adjacent to the earphone unit 601 so as not to interfere with the antenna 602 of the earphone unit 601. The earphone unit cover part 603 may support and fix another portion of the earphone unit 601 to prevent performance degradation of the antenna 602 as the earphone unit cover part 603 does not occlude the portion in which the antenna 602 is built.

Referring to FIG. 6B, a side view of the inside of the earphone unit 601 is illustrated.

The earphone unit 601 may include the antenna 602, a carrier 604, a printed board assembly (PBA) 605, and an antenna receptacle 606. The PBA 605 may be coupled to the antenna receptacle 606. The antenna receptacle 606 may be coupled to the antenna 602 via an antenna contact 607. The antenna 602 may be supported by the carrier 604. The antenna 602 may form a specific pattern. The antenna 602 may be a radio frequency (RF) antenna but is not limited thereto.

The earphone unit cover part 603 may support the earphone unit 601 but may not occlude the antenna 602, and thereby, the performance of the antenna 602 may not be degraded.

Hereinafter, a case in which a unit (e.g., the unit 603) supporting an earphone unit (e.g., the earphone unit 601) includes an antenna is described.

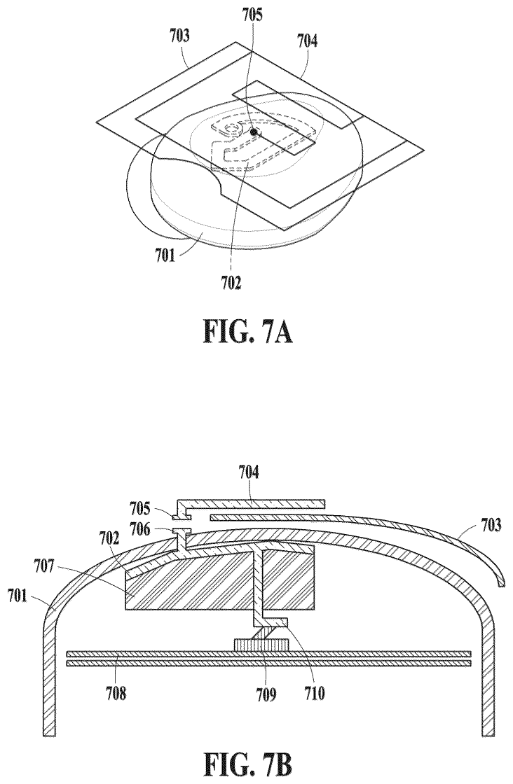

FIG. 7A and FIG. 7B are diagrams illustrating an earphone unit and an earphone unit cover part including an antenna according to an embodiment of the present disclosure.

FIG. 7A is a diagram illustrating coupling of an earphone unit 701 to a unit 703 supporting the earphone unit 701. FIG. 7B is a side view of an internal structure to describe the coupling of the earphone unit 701 to the unit 703 supporting the earphone unit 701.

The unit 703 supporting the earphone unit 701 may be an earphone unit cover part (e.g., the earphone unit cover part 306 of FIG. 3 and the earphone unit cover part 403 of FIG. 4) and a cradle unit cover part (e.g., the cradle unit cover part 513 of FIG. 5). Hereinafter, the description is provided based on the earphone unit cover part for ease of description, but the description thereof may apply to the cradle unit cover part.

Referring to FIG. 7A, the earphone unit 701 (e.g., the earphone unit 601 of FIG. 6A and the earphone unit 601 of FIG. 6B) and the earphone unit cover part 703 (e.g., the earphone unit cover part 306 of FIG. 3, the earphone unit cover part 403 of FIG. 4, the earphone unit cover part 601 of FIG. 6A, and the earphone unit cover part 603 of FIG. 6B) are illustrated.

The earphone unit 701 may be a first earphone unit (e.g., the first earphone unit 310 of FIG. 3) and a second earphone unit (e.g., the second earphone unit 311 of FIG. 3).

The earphone unit cover part 703 may include an antenna 704. The antenna 704 may be an example of the antenna module 197 of FIG. 1. The antenna 704 may form a specific pattern. One end of the antenna 704 may include an antenna contact 705 that may be connected to an antenna 702 (e.g., the earphone unit 601 of FIG. 6A and the antenna 602 of FIG. 6B) of the earphone unit 701. When the earphone unit cover part 703 includes the antenna 704, the earphone unit cover part 703 may be connected to the antenna 702 of the earphone unit 701 via the antenna contact 705. According to an embodiment, when the earphone unit cover part 703 includes the antenna 704 and is connected to the antenna 702 of the earphone unit 701 via the antenna contact 705, an antenna pattern may be extended and the performance of the antenna may increase. In this case, only the antenna may be extended to an area of the headphones and wireless communication with the user terminal may still be performed by the earphone unit 701. However, when the headphones include a wireless communication integrated circuit (IC), the wireless communication with the user terminal may be performed by the headphones.

Referring to FIG. 7B, a side view of an inside of the earphone unit 701 is illustrated.

The earphone unit 701 may include the antenna 702, an external contact 706, a carrier 707 (e.g., the carrier 604 of FIG. 6B), a PBA 708 (e.g., the PBA 605 of FIG. 6B), and an antenna receptacle 709 (e.g., the antenna receptacle 606 of FIG. 6B). The PBA 708 may be coupled to the antenna receptacle 709. The antenna receptacle 709 may be coupled to the antenna 702 via the antenna contact 710 and may support the antenna 702. The antenna 702 may be supported by the carrier 707. The antenna 702 may form a specific pattern. The antenna 702 may be an RF antenna but is not limited thereto.

The antenna 702 of the earphone unit 701 may be electrically connected to the antenna 704 of the earphone unit cover part 703. One end of the antenna 702 may be connected to the external contact 706 outwardly protruding. The external contact 706 may contact the antenna contact 705 connected to one end of the antenna 704. The external contact 706 and the antenna contact 705 may be pogo pins but are not limited thereto. When the antenna of the earphone unit 701 is connected to the antenna 704 of the earphone unit cover part 703 via the external contact 706 and the antenna contact 705, the performance of the antenna may be improved as the antenna pattern is extended. According to an embodiment, the antenna 702 and the external contact 706 may be integrally formed. The external contact 706 may be an end of the antenna 702 and may have a shape protruding outside the earphone unit 701. According to an embodiment, the external contact 706 may be disposed inside a housing of the earphone unit 701. In this case, the antenna contact 705 and the external contact 706 may contact inside the housing of the earphone unit 701. According to an embodiment, the antenna 702 of the earphone unit 701 may be coupled and connected to the antenna of the earphone unit cover part 703.

Hereinafter, a method of extending an antenna when a unit supporting an earphone unit includes the antenna is described.

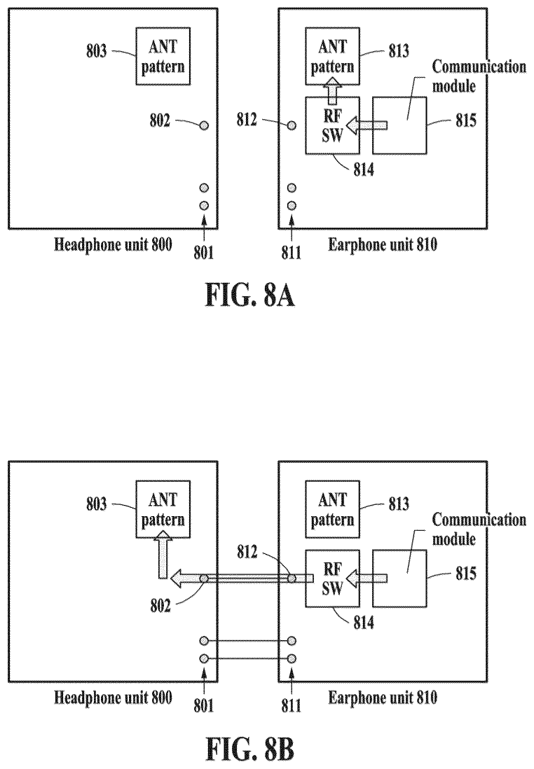

FIG. 8A and FIG. 8B are diagrams illustrating an earphone unit and antenna extension of headphones according to an embodiment of the present disclosure.

Referring to FIG. 8A and FIG. 8B, a headphone unit 800 (e.g., the electronic device 101 of FIG. 1 and the headphone device 300 of FIG. 3), an interface 801 (e.g., the interface 304 of FIG. 3, the interface 401 of FIG. 4, and the interface 501 of FIG. 5), an antenna contact 802 (e.g., the antenna contact 705 of FIG. 7A and the antenna contact 705 of FIG. 7B), and an antenna (e.g., the antenna 704 of FIG. 7A and the antenna 704 of FIG. 7B) are illustrated. Referring to FIG. 8, an earphone unit 810 (e.g., the earphone unit 601 of FIG. 6A, the earphone unit 601 of FIG. 6B, the earphone unit 701 of FIG. 7A, and the earphone unit 701 of FIG. 7B), an interface 811 (e.g., the interfaces 312 and 313 of FIG. 3), an external contact 812 (e.g., the external contact 706 of FIG. 7B), an antenna 813 (e.g., the antenna 602 of FIG. 6A, the antenna 602 of FIG. 6B, the antenna 702 of FIG. 7A, and the antenna 702 of FIG. 7B), an RF switch 814, and a communication module 815 are illustrated.

The headphone unit 800 may include the antenna 803. For example, an earphone unit cover part (e.g., the earphone unit cover part 306 of FIG. 3 and the earphone unit cover part 403 of FIG. 4) of the headphone unit 800 may include an antenna pattern. Alternatively, a cradle unit cover part (e.g., the cradle unit cover part 513 of FIG. 5) of a cradle unit (e.g., a cradle unit 511 of FIG. 5) may include the antenna pattern.

The earphone unit 810 may be a first earphone unit (e.g., the first earphone unit 310 of FIG. 3) or a second earphone unit (e.g., the second earphone unit 311 of FIG. 3).

FIG. 8A is a diagram illustrating when the earphone unit 810 is not coupled to the headphone unit 800 and is used alone.

When the earphone unit 810 is used alone, the interface 811 of the earphone unit 810 may not be connected to the interface 801 of the headphone unit 800. For example, when the earphone unit 810 is not coupled to the headphone unit 800, the external contact 812 connected to an end of the antenna pattern of the earphone unit may not be connected to the antenna contact 802 of the headphone unit 800. In this case, the RF switch 814 may cause the communication module 815 to be connected to the antenna 813 of the earphone unit 810. The communication module 815 may support Bluetooth and/or Bluetooth low energy (BLE). However, a communication protocol supported by the communication module 815 is not limited to Bluetooth or BLE.

FIG. 8B is a diagram illustrating when the earphone unit 810 is coupled to the headphone unit 800 and used together.

When the earphone unit 810 is used together with the headphone unit 800, the interface 811 of the earphone unit 810 may be connected to the interface 801 of the headphone unit 800. In other words, the earphone unit 810 may be coupled to the headphone unit 800. In this case, the external contact 812 connected to one end of the antenna 813 of the earphone unit 810 may be electrically connected to the antenna contact 802 of the headphone unit 800. When the earphone unit 810 is coupled to the headphone unit 800, the RF switch 814 may switch the communication module 815 to be connected to the antenna 803 of the headphone unit 800. When the antenna 813 is switched to be connected to the antenna 803 of the headphone unit 800, the length of the antenna may be extended and thereby, the performance of the antenna may be improved. Specifically, the performance of the antenna may be improved by overcoming the limitation of the earphone unit 810 in which the antenna 813 is disposed only in an area occluded by an ear of the user as the antenna 803 of a large pattern included in a headphone housing is connected to the antenna 813 of the earphone unit 810. According to an embodiment, when the earphone unit 810 is coupled to the headphone unit 800, the RF switch 814 may switch to select the antenna 803 of the headphone unit 800 through switching.

When the earphone unit 810 is separated from the headphone unit 800, the RF switch 814 may switch the communication module 815 again to be connected to the antenna 813 of the earphone unit 810.

Hereinafter, when the headphone unit 800 is coupled to the earphone unit 810, an operating method thereof is described with various embodiments.

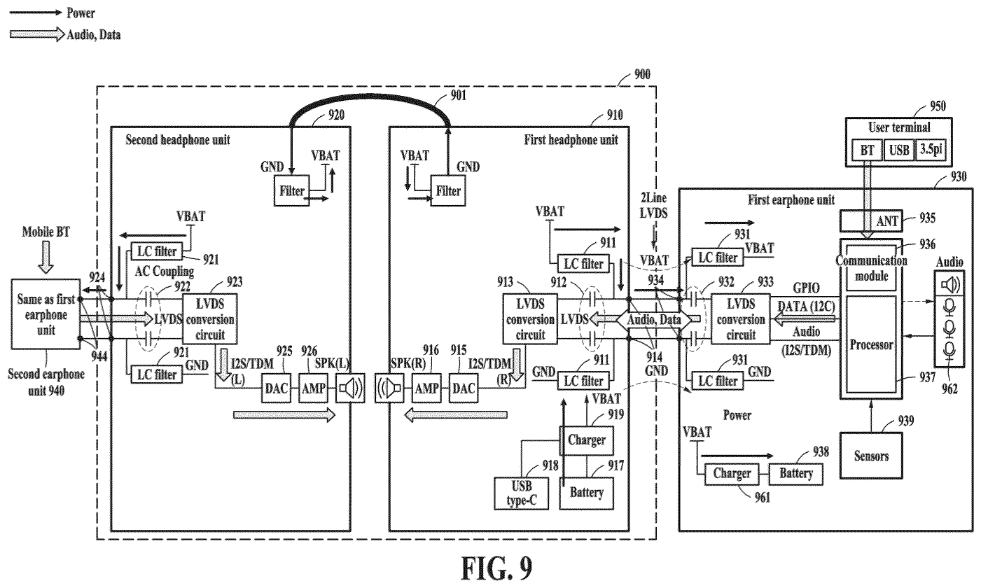

FIG. 9 is a block diagram illustrating a flow of data and power when an earphone unit processes an operation according to an embodiment of the present disclosure.

Referring to FIG. 9, a headphone device 900 (e.g., the electronic device 101 of FIG. 1 and the headphone device 300 of FIG. 3), an earphone unit (e.g., the earphone unit 601 of FIG. 6A, the earphone unit 601 of FIG. 6B, the earphone unit 701 of FIG. 7A, and the earphone unit 701 of FIG. 7B), and a user terminal 950 are illustrated.

The headphone device 900 may include a headband 901 (e.g., the headband 301 of FIG. 3), a first headphone unit 910 (e.g., the first headphone unit 302 of FIG. 3) connected to an end of the headband 901, and a second headphone unit 920 (e.g., the second headphone unit 303 of FIG. 3) connected to the other end of the headband 901. The second headphone unit 920 may be electrically connected to the first headphone unit 910 via a conducting wire included in the headband 901.

The earphone unit may be a first earphone unit 930 (e.g., the first earphone unit 310 of FIG. 3) or a second earphone unit 940 (e.g., the second earphone unit 311 of FIG. 3).

The user terminal 950 may be a terminal that may communicate with the earphone unit or the headphone device wirelessly or by wire. The user terminal 950 may communicate with the earphone unit or the headphone device by wire via a USB terminal or a 3.5 pi terminal. The user terminal 950 may communicate with the earphone unit or the headphone device wirelessly via a Bluetooth IC.

In an embodiment, the user terminal 950 may include various computing devices, such as a mobile phone, a smartphone, a tablet personal computer (PC), an e-book device, a laptop, a PC, a desktop, a workstation, or a server, various wearable devices, such as a smart watch, smart eyeglasses, a head-mounted display (HMD), or smart clothing, various home appliances such as a smart speaker, a smart television (TV), or a smart refrigerator, and other devices, such as a smart vehicle, a smart kiosk, an IoT device, a walking assist device (WAD), a drone, or a robot.

According to an embodiment of the present disclosure, when an earphone unit (e.g., a processor 937 included in the first earphone unit 930) is used as a main processing unit, a redundant device of the earphone unit may be removed from the headphone device 900. For example, redundant sensors and microphones of the first earphone unit 930 may be removed from the first headphone unit 910. In this case, wireless communication with the user terminal 950 and data operation processing may be performed by the earphone unit and sound may be output through a speaker included in the headphones. A large speaker driver included in the headphones may output high-quality sound and the headphones may shield external noise. In addition, the headphone device may be lightened by removing a redundant device from the earphone unit.

Hereinafter, a description is provided based on the first headphone unit 910 and the first earphone unit 930. Since the description of the first headphone unit 910 is applicable to the second headphone unit 920, the description of the second headphone unit 920 is omitted. In addition, since the description of the first earphone unit 930 is applicable to the second earphone unit 940, the description of the second earphone unit 940 is omitted.

Hereinafter, a flow of data and power when an earphone unit processes an operation is described. Firstly, a flow of data transmission is described.

The first earphone unit 930 may include an LC filter 931, a capacitor 932, a low-voltage differential signaling (LVDS) conversion circuit 933, a first interface 934 (e.g., the interface 312 of FIG. 3), an antenna 935 (e.g., the antenna 602 of FIG. 6A, the antenna 602 of FIG. 6B, the antenna 702 of FIG. 7A, the antenna 702 of FIG. 7B, the antenna 813 of FIG. 8A, and the antenna 813 of FIG. 8B), a communication module 936 (e.g., the communication module 815 of FIG. 8A and the communication module 815 of FIG. 8B), a processor 837, a battery 938, and a plurality of sensors 939. According to an embodiment, the first interface sensor, an acceleration sensor, a hall sensor, and a proximity sensor, but is not limited thereto and may include any device that may collect surrounding information.

The communication module 936 may receive second data including audio data from the user terminal 950 via the antenna 935.

The first earphone unit 930 may collect third data using a microphone 962 or the plurality of sensors 939. For example, the first earphone unit 930 may collect external sound data via the microphone 962.

The processor 937 may include at least one or a combination of two or more of a microcontroller unit (MCU) and a digital signal processor (DSP). The processor 937 may integrate and process the second data and the third data. Original data, which includes general purpose input/output (GPIO), integrated interchip sound (I2S), or I2S/time division multiplexing (TDM) and is generated by being processed through the processor 937, may be transmitted to the LVDS conversion circuit 933 of the first earphone unit 930. The original data may be referred to as first data depending on the embodiment.

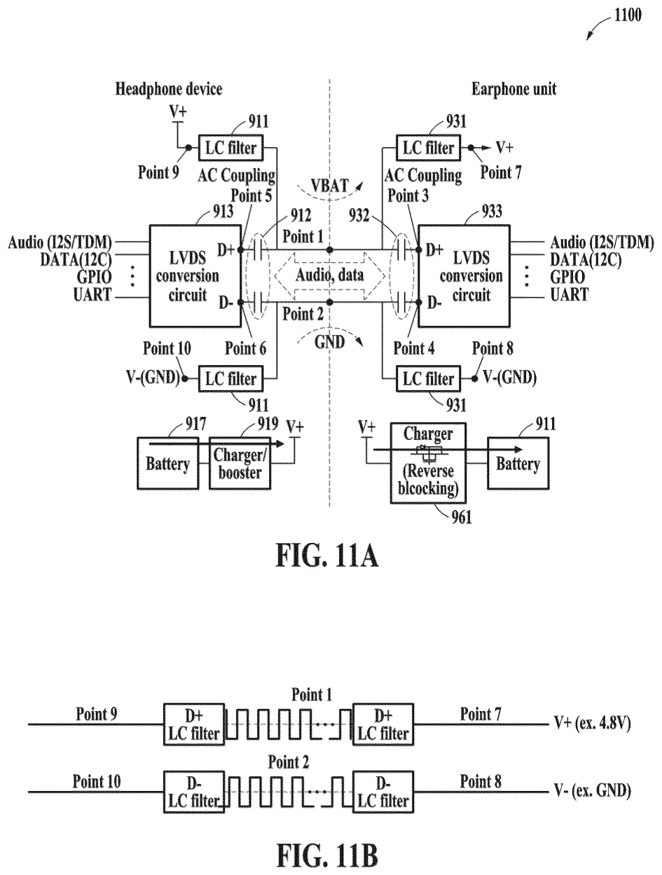

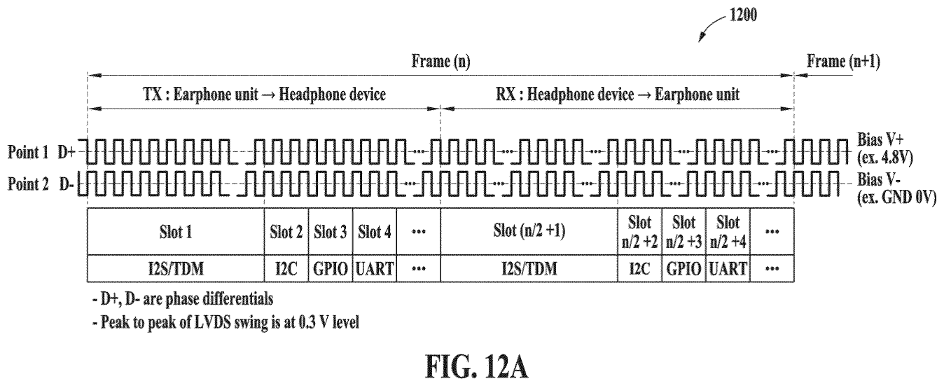

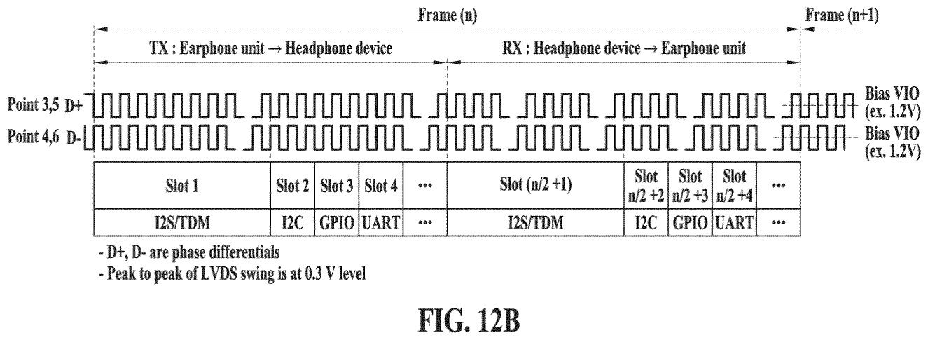

The LVDS conversion circuit 933 of the first earphone unit 930 may convert a signal of the received original data into an LVDS signal by multiplexing. The LVDS conversion circuit 933 of the first earphone unit 930 may transmit the LVDS signal to an LVDS conversion circuit 913 of the first headphone unit 910 at high speed through bidirectional one-channel two-lines. The bidirectional one-channel two-line may connect the first earphone unit 930 to the first headphone unit 910 via the first interface 934 of the first earphone unit 930 and a first interface 914 of the first headphone unit. The transmission of the LVDS signal is further described with reference to FIGS. 11 and 12.

The communication between the headphone device 900 and the earphone unit may use LVDS communication capable of power and data communication. The LVDS communication may transmit data at a bandwidth of more than a few Mbps.

The capacitor 912 may be connected in series to two lines on a first headphone unit 910 side. The capacitor 932 may be connected in series to two lines on a first earphone unit 930 side. The capacitor 912 may be an alternating current (AC) coupling capacitor and may block a direct current (DC) component input to the LVDS conversion circuit 913 of the first headphone unit 910. The capacitor 932 may be an AC coupling capacitor and may block a DC component input to the LVDS conversion circuit 933 of the first earphone unit 930.

The first headphone unit 910 may include the LC filter 911, the capacitor 912, the LVDS conversion circuit 913, the first interface 914 (e.g., the interface 401 of FIG. 4 and the interface 501 of FIG. 5), a digital-to-analog converter (DAC) 915, an amplifier (AMP) 916, a speaker, a second interface (e.g., a USB-C terminal 918), a battery 917, and a charger 919. According to an embodiment, the first interface 914 may include a pogo pin.

The LVDS conversion circuit 913 of the first headphone unit 910 may convert the received LVDS signal into the original data, which is the data before being converted. The DAC 915 (e.g., the DAC 250 of FIG. 2) may convert audio data included in the original data into an analog signal. The AMP 916 may receive and amplify the analog signal from the DAC 915. The speaker may output the signal amplified by the AMP 916 as sound. The speaker may be an example of the sound output module 155 of FIG. 1.

Hereinafter, a flow of power transmission is described.

The headphone device 900 may receive power from an external power source via a second interface that may be connected to the outside. The second interface may include a USB. For example, the second interface may be a USB-C terminal, a 5-pin terminal, or an 8-pin terminal. Hereinafter, a description is provided based on an assumption that the headphone device 900 includes a USB-C terminal 918.

The USB-C terminal 918 may be connected to an external power source. When the USB-C terminal 918 is connected to the external power source, the headphone device 900 may receive power from the external power source. The received power may be stored in the battery 917. The power stored in the battery 917 may be used to operate the headphone device 900. For example, the power stored in the battery 917 may be supplied to the LVDS conversion circuit 913, the DAC 915, and/or the AMP 916 of the first headphone unit 910. In addition, the power stored in the battery 917 may be supplied to the second headphone unit 920 from the first headphone unit 910 through a power line (e.g., a transmission line, a cable, or a flexible PCB (FPCB)) included in the headband 901.

In an embodiment, when the first earphone unit 930 is coupled to the first headphone unit 910, the battery 917 may charge the battery 938 of the first earphone unit 930 by supplying the stored power to the first earphone unit 930. The charger 919 of the first headphone unit 910 may determine whether the first headphone unit 910 is coupled to the first earphone unit 930. A charger 961 of the first earphone unit 930 may determine whether the first earphone unit 930 is coupled to the first headphone unit 910.

The power supplied from the first headphone unit 910 to the first earphone unit 930 may be stored in the battery 938 of the first earphone unit 930. In this case, the power may be transmitted as one of the two lines is connected to a ground and the other is connected to VBAT. The power may be transmitted to the first earphone unit 930 by passing through a section isolated by the AC coupling capacitors 912 and 932. The power transmitted to the first earphone unit 930 may be connected to the battery 938 of the first earphone unit 930 through the LC filter 931. The LC filter 931 may block an LVDS signal which is an AC component.

In addition, the power may be transmitted to the second headphone unit 920 through the headband 901 connected to the first headphone unit 910. The second headphone unit 920 may store the transmitted power in a battery included in the second headphone unit 920. According to an embodiment, when the second headphone unit 920 includes a separate battery, the charger 919 of the first headphone unit 910 may directly transmit the power to the second headphone unit 920 via a power line included in the headband 901.

When the second headphone unit 920 is coupled to the second earphone unit 940 like the first headphone unit 910, the second headphone unit 920 may charge the battery of the second earphone unit 940 via the first interface 924 and a first interface 944. When the second earphone unit 940 is coupled to the headphone device 900, a user may use the second earphone unit 940 while charging the second earphone unit 940.

Hereinafter, operations of an earphone unit and headphones are described using a flowchart.

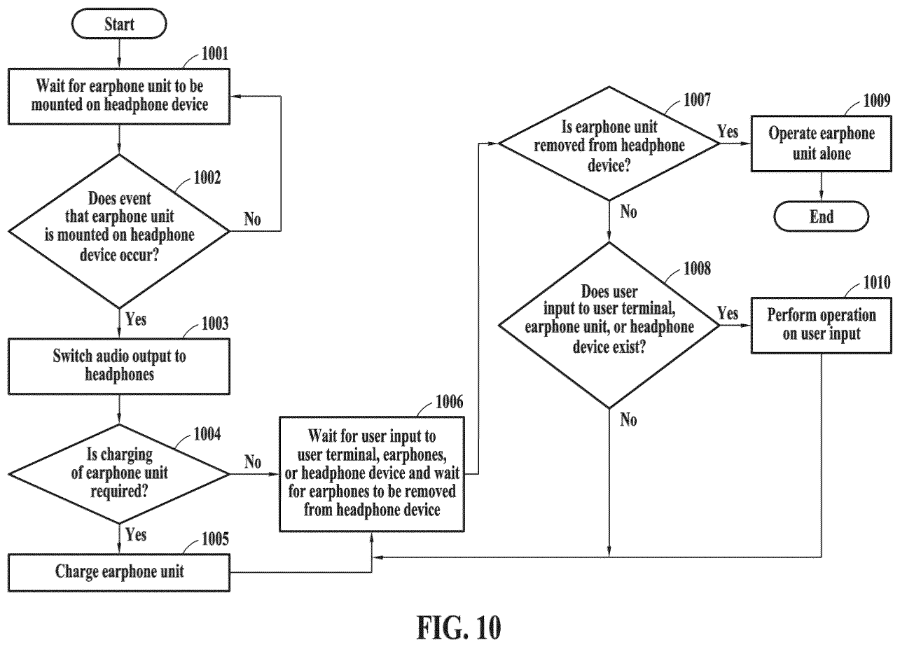

FIG. 10 is a flowchart illustrating operations of an earphone unit and headphones when the earphone unit processes an operation according to an embodiment of the present disclosure.

Operations to be described hereinafter may be sequentially performed but not necessarily. For example, the order of the operations may change, and at least two of the operations may be performed in parallel. Operations 1001 to 1010 may be performed by a headphone device (e.g., the headphone device 300 of FIG. 3 and the headphone device 900 of FIG. 9) and/or an earphone unit (e.g., the earphone unit 601 of FIG. 6A, the earphone unit 601 of FIG. 6B, the earphone unit 701 of FIG. 7A, the earphone unit 701 of FIG. 7B, the earphone unit 810 of FIG. 8A, and the earphone unit 810 of FIG. 8B).

In operation 1001, the headphone device and/or the earphone unit may wait for the earphone unit to be mounted on the headphone device. The headphone device may wait for the earphone unit to be mounted on the headphone device. The earphone unit may wait for the earphone unit to be mounted on the headphone device. For example, the headphone device or the earphone unit may wait for the earphone unit to be mounted on the headphone device and may periodically determine whether the earphone unit is mounted.

In operation 1002, the headphone device and/or the earphone unit may determine whether an event that the earphone unit is mounted on the headphone device occurs. The headphone device may determine whether an event that the earphone unit is mounted on the headphone device occurs. The earphone unit may determine whether an event that the earphone unit is mounted on the headphone device occurs. For example, the headphone device or the earphone unit may determine whether the earphone unit is coupled to the headphone device. The headphone device or the earphone unit may determine whether the earphone unit or a cradle unit (e.g., the cradle unit 511 of FIG. 5) is coupled to an earphone unit coupling portion (e.g., the earphone unit coupling portion 305 of FIG. 3 and the earphone unit coupling portion 402 of FIG. 4) or a cradle unit coupling portion (e.g., the cradle unit coupling portion 502 of FIG. 5) of the headphone device. In this case, when the earphone unit is not coupled to the headphone device, operation 1001 may be performed. When the earphone unit is coupled to the headphone device, operation 1003 may be performed.

In operation 1003, the earphone unit may switch audio output from the earphone unit to the headphone device. For example, when the earphone unit is coupled to the headphone device while outputting audio, the audio may be output from a speaker of the headphone device.

In operation 1004, the headphone device and/or the earphone unit may determine whether the earphone unit needs to be charged. The headphone device may determine whether the earphone unit needs to be charged. The earphone unit may determine whether the earphone unit needs to be charged. When charging is needed, operation 1005 may be performed. When charging is not needed, operation 1006 may be performed.

In operation 1005, when charging is needed, the earphone unit may be charged. For example, when charging is needed, the headphone device may charge a battery (e.g., the battery 938 of FIG. 9) of the earphone unit using at least a portion of power stored in a battery (e.g., the battery 917 of FIG. 9) and/or power received from an external power source.

In operation 1006, the headphone device or the earphone unit may wait for a user input to the earphone unit or the headphone device or removal of the earphone unit from the headphone device. The headphone device may wait for a user input to a user terminal, the earphone unit, or the headphone device or removal of the earphone unit from the headphone device. The earphone unit may wait for a user input to a user terminal, the earphone unit, or the headphone device or removal of the earphone unit from the headphone device.

In operation 1007, the headphone device and/or the earphone unit may determine whether the earphone unit is removed from the headphone device. The headphone device may determine whether the earphone unit is removed from the headphone device. The earphone unit may determine whether the earphone unit is removed from the headphone device. When the earphone unit is removed, operation 1009 may be performed. When the earphone unit is not removed, operation 1008 may be performed.

In operation 1009, when the earphone unit is removed, the earphone unit may operate alone. For example, when the earphone unit is removed while the headphones output audio, only the earphone unit may output the audio.

In operation 1008, the headphone device or the earphone unit may determine whether a user input to the user terminal, the earphone unit, or the headphone device exists. The headphone device may determine whether a user input to the user terminal, the earphone unit, or the headphone device exists. The earphone unit may determine whether a user input to the user terminal, the earphone unit, or the headphone device exists. When the user input exists, operation 1010 may be performed. When the user input does not exist, operation 1006 may be performed.

In operation 1010, when the user input exists, the headphone device or the earphone unit may perform an operation for the user input. For example, when the user performs an operation of decreasing a volume level of an audio output, the headphone device and/or the earphone unit may decrease the volume level of the audio output. When the user performs an operation of pausing the audio output, the headphone device and/or the earphone unit may pause the audio output.

FIG. 11A and FIG. 11B are diagrams illustrating communication between headphones and an earphone unit according to an embodiment of the present disclosure.

Referring to FIG. 11, the LVDS conversion circuit 913s and 923 of a first headphone unit (e.g., the first headphone unit 302 of FIG. 3 and the first headphone unit 910 of FIG. 9) and the LVDS conversion circuit 933 of a first earphone unit (e.g., the first earphone unit 310 of FIG. 3 and the first earphone unit 930 of FIG. 9) are illustrated.

FIG. 11A is a diagram illustrating the transmission and reception of data and power between an earphone unit and a headphone device (e.g., the headphone device 300 of FIG. 3 and the headphone device 900 of FIG. 9). Hereinafter, the description is provided based on a case in which data is transmitted from the earphone unit to the headphone device.

The LVDS conversion circuit 933 may convert original data including GPIO, I2S, inter-IC (I2C) and/or a universal asynchronous receiver/transmitter (UART) into an LVDS signal. The LVDS conversion circuit 933 may convert the original data including GPIO, I2S, I2C, and/or UART into the LVDS signal by multiplexing. For example, the LVDS conversion circuit 933 may convert the original data including GPIO, I2S, I2C, and/or UART into an LVDS signal which is a reverse phase and swings at a specific peak-to-peak voltage.

For example, the LVDS conversion circuit 933 may convert the original data including GPIO, I2S, I2C, and/or UART into an LVDS signal which is a differential signal and swings at a specific peak-to-peak voltage.

For example, the LVDS conversion circuit 933 may convert the original data into the LVDS signal which is a differential signal having D+ and D− and swings at peak-to-peak 0.3V. The LVDS signal may be transmitted at a high speed of Mbps.

The LVDS conversion circuit 933 may be connected to the LVDS conversion circuit 913 of the headphone device via two lines. The two lines may be respectively connected to the capacitors 912 of the earphone unit and the headphone device. The capacitors 912 and 932, which are the AC coupling capacitors, may block a DC component and may pass only an AC component. For example, the capacitors 912 and 932 may block VIO bias power, which is a DC component, and may pass only an LVDS signal, which is an AC component. Only the LVDS signal may be transmitted to the LVDS conversion circuit 913 from the LVDS conversion circuit 933.

Point 1 may be biased to V+ power and point 2 may be biased to V− power. The biased power, which is a DC component, may be blocked from the capacitor 912 of the headphone device and only the LVDS signal may be input to the LVDS conversion circuit 913.

If needed, point 5 and point 6 of the headphone device may be biased to VIO power. In this case, waveforms of points 5 and 6 may be reconstructed waveforms of points 3 and 4 of the earphone unit. The LVDS conversion circuit 913 may convert the received LVDS signal into the original data. The LVDS conversion circuit 913 may reconstruct the received LVDS signal to the original data. The transmission of data from headphones to earphones may be identically operated as described above.

Hereinafter, a process of transmitting power stored in a headphone device to an earphone unit is described. The headphone device or the earphone unit may wait for a condition in which the charging of the headphone device and the earphone unit is completed. The headphone device or the earphone unit may wait for the coupling of the headphone device to the earphone unit. The headphone device or the earphone unit may wait to be electrically connected to each other via two or more contacts. For example, the charger 919 of the first headphone unit 910 and the charger 961 of the first earphone unit 930 may determine whether the headphone unit and the earphone unit are electrically connected to each other via two or more contacts.

When the headphone device is coupled to the earphone unit, the charger 919 of the headphone unit may output a voltage required to charge the earphone unit. The charger 919 of the headphone unit may output a voltage boosted by a booster. The output voltage may be input to the earphone unit. The charger 961 of the earphone unit may block backward transmission in which the power is supplied from the battery 938 of the earphone unit to the battery 917 of the headphone device. The power may be transmitted only to the earphone unit from the headphone device. In this case, the power transmitted between the headphone device and the earphone unit may be adjusted by the LVDS signal via two lines. For example, a V+ voltage of the power output from the charger 919 of the headphone unit may be adjusted through LVDS communication with the charger 961 of the earphone unit.

FIG. 11B is a diagram illustrating a waveform at each point.

Points 9 and 7 may be connected through the LC filter 911 of the headphone device, the capacitor 912 connected to a line of the headphone device, a section having a D+phase separated by the capacitor 932 connected to a line of the earphone unit, and the LC filter 931 of the earphone unit. Similarly, points 10 and 8 may be connected to the LC filter 911 of the headphone device, the capacitor 912 connected to a line of the headphone device, a section having a V− phase separated by the capacitor 932 connected to a line of the earphone unit, and the LC filter 931 of the earphone unit.

At point 9, only a DC component may be detected as an LVDS signal, which is an AC component, is blocked by the LC filter 911. At point 7, only a DC component may be detected as an LVDS signal, which is an AC component, is blocked by the LC filter 931. Points 9 and 7 may be V+, which is the same potential difference because only the DC component that is in a low-frequency band is passed. For example, the potential of points 9 and 7 may be 4.8 V and may be a DC component.

At point 10, only a DC component may be detected as an LVDS signal, which is an AC component, is blocked by the LC filter 911. At point 8, only a DC component may be detected as an LVDS signal, which is an AC component, is blocked by the LC filter 931. Points 10 and 8 may be V−, which is the same potential difference because only the DC component that is in a low-frequency band is passed. For example, the potential of points 10 and 8 may be ground and may be 0 V.

In other words, the power of the DC component may be transmitted to the earphone unit from the headphone device by being separated from an LVDS high-speed signal through the LC filters 911 and 931. If needed, a filter may be added other than the LC filters 911 and 931 and the AC coupling capacitors 912 and 932.

At points 1 and 2, an LVDS signal, which is an AC signal, may be detected. In this case, an AC signal of a reverse phase may be detected at points 1 and 2. At points 1 and 2, an AC signal of a differential signal may be detected. Hereinafter, a method of transmitting data by DC biasing to a differential signal is described.

FIG. 12A and FIG. 12B are diagrams illustrating a signal according to communication between headphones and an earphone unit according to an embodiment of the present disclosure.

Referring to FIG. 12A, a waveform diagram 1200 showing a DC bias, an AC component, and a slot at points 1 to 6 of FIG. 11A is illustrated.

The LVDS communication may use a TDM scheme. The LVDS signal may include a plurality of frames over time. The frame may be used for transmission and reception. Half of the frames may be used for Tx and the other half may be used for Rx. Tx may be a case in which data is transmitted to an earphone unit (e.g., the first earphone unit 310 of FIG. 3, the second earphone unit 311 of FIG. 3, the first earphone unit 930 of FIG. 9, or the second earphone unit 940 of FIG. 9) to a headphone device (e.g., the headphone device 300 of FIG. 3 or the headphone device 900 of FIG. 9). Rx may be a case in which data is transmitted from the headphone device to the earphone unit. Tx and Rx may include a plurality of slots. An LVDS conversion circuit may allocate data to be transmitted to the plurality of slots. The LVDS conversion circuit may transmit the data using a differential signal via two lines.

FIG. 12A is a diagram illustrating the LVDS communication at points 1 and 2 of FIG. 11A. Referring to FIG. 12A, an n-th frame of an LVDS signal is illustrated. Half of the frames may be used for Rx and the other half may be used for Tx. Hereinafter, a description is provided based on Tx, but the description of Tx may apply to Rx.

Tx may include a plurality of slots. GPIO, I2S, I2C, and/or UART included in original data to be transmitted by the earphone unit to the headphone device may be allocated to each of the plurality of slots. The data allocated to the plurality of slots may be transmitted from the earphone unit to the headphone device as a differential signal via two lines. For example, the data allocated to the plurality of slots may be transmitted from the earphone unit to the headphone device via a first line having a D+ phase and a second line having a D− phase. The data allocated to the plurality of slots may be DC biased to a reverse phase and may be transmitted from the earphone unit to the headphone device. For example, point 1 may be V+ biased. Point 2 may be ground biased. The LVDS signal may be a signal that swings at peak-to-peak 0.3 V.

FIG. 12B is a diagram illustrating LVDS communication at points 3 to 6 of FIG. 11A. Referring to FIG. 12B, an n-th frame of an LVDS signal is illustrated. Half of the frames may be used for Rx and the other half may be used for Tx. Hereinafter, a description is provided based on Tx, but the description of Tx may apply to Rx.

Tx may include a plurality of slots. GPIO, I2S, I2C, and/or UART included in original data to be transmitted by the earphone unit to the headphone device may be allocated to each of the plurality of slots. The data allocated to the plurality of slots may be transmitted from the earphone unit to the headphone device as a reverse phase signal via two lines. For example, the data allocated to the plurality of slots may be transmitted from the earphone unit to the headphone device via a first line having a D+ phase and a second line having a D− phase. The data allocated to the plurality of slots may be VIO biased in the reverse phase and may be transmitted form the earphone unit to the headphone device. The LVDS signal may be a signal that swings at peak-to-peak 0.3 V.

Hereinafter, a case in which a headphone device includes a separate sensor is described.

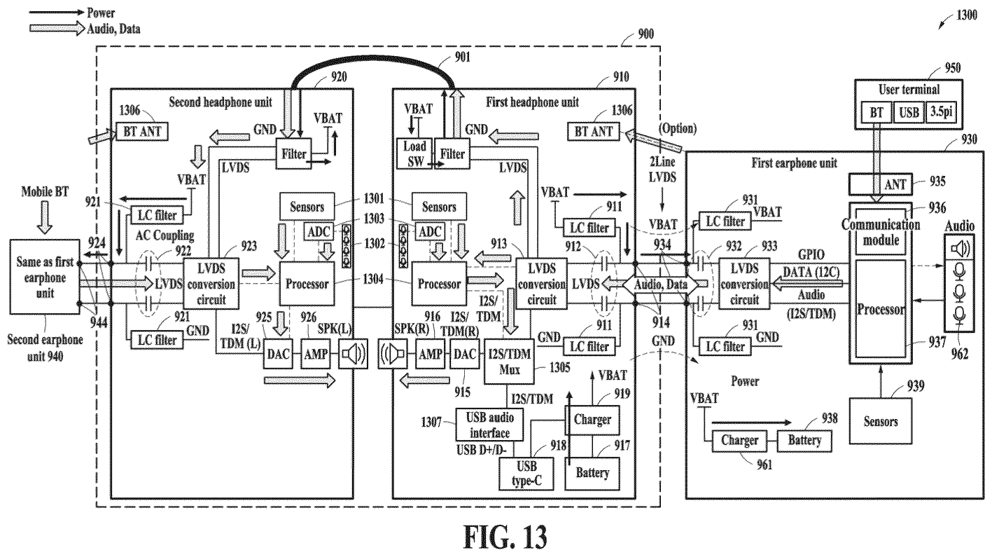

FIG. 13 is a block diagram 1300 illustrating headphones that include a plurality of sensors and are coupled to an earphone unit according to an embodiment of the present disclosure.

Referring to FIG. 13, the headphone device 900 (e.g., the headphone device 300 of FIG. 3 and the headphone unit 900 of FIG. 9), an earphone unit (e.g., the earphone unit 601 of FIG. 6A, the earphone unit 601 of FIG. 6B, the earphone unit 701 of FIG. 7A, and the earphone unit 701 of FIG. 7B), and the user terminal 950 are illustrated.

The headphone device 900 may include a headband 901 (e.g., the headband 301 of FIG. 3), a first headphone unit 910 (e.g., the first headphone unit 302 of FIG. 3) connected to an end of the headband 901, and a second headphone unit 920 (e.g., the second headphone unit 303 of FIG. 3) connected to the other end of the headband 901. The second headphone unit 920 may be electrically connected to the first headphone unit 910 via a conducting wire included in the headband 901.

Referring to FIG. 13, the first headphone unit 910 and the second headphone unit 920 may include at least one or a combination of two or more of a plurality of sensors 1301, a plurality of microphones 1302, an ADC 1303 (e.g., the ADC 230 of FIG. 2), a processor 1304, a multiplexer 1305, and a Bluetooth antenna 1306.

The earphone unit may be a first earphone unit 930 (e.g., the first earphone unit 310 of FIG. 3) or a second earphone unit 940 (e.g., the second earphone unit 311 of FIG. 3).

The user terminal 950 may be a terminal that may communicate with the earphone unit or the headphone device 900 wirelessly or by wire. The user terminal 950 may communicate with the earphone unit or the headphone device 900 by wire via a USB terminal or a 3.5 pi terminal. The user terminal 950 may communicate with the earphone unit or the headphone device 900 wirelessly via a Bluetooth IC.

According to an embodiment, the user terminal 950 may include various computing devices, such as a mobile phone, a smartphone, a tablet PC, an e-book device, a laptop, a PC, a desktop, a workstation, or a server, various wearable devices, such as a smartwatch, smart eyeglasses, an HMD, or smart clothing, various home appliances such as a smart speaker, a smart TV, or a smart refrigerator, and other devices, such as a smart vehicle, a smart kiosk, an IoT device, a WAD, a drone, or a robot.

According to an embodiment of the present disclosure, the processor 937 included in an earphone unit (e.g., the first earphone unit 930) may be used as a main processing unit and the headphone device 900 may include devices, such as the plurality of microphones 1302, the Bluetooth antenna 1306, and/or the plurality of sensors 1301. In this case, the functionality of the headphone device may be expanded by integrating the data secondarily processed by the headphone device in addition to the data primarily processed by the earphone unit. For example, the earphone unit may primarily process data collected by the plurality of sensors 939 including the acceleration sensor and the gyro sensor of the earphone unit and in addition to the data received from the user terminal 950 via Bluetooth communication and may transmit the processed data to the headphone device. In this case, the headphone device may process the received data and the data collected by the sensor included in the headphone device using the processor 1304, such as an MCU and a DSP. The headphone device according to an embodiment may use a high-performance feature, such as multi-microphone, active noise cancellation (ANC), 360 audio, or multi-microphone beamformer, using the processed data.

According to an embodiment of the present disclosure, when the headphone device includes a Bluetooth antenna, the antenna may be extended by connecting to the antenna of the earphone unit. The performance of the antenna may be improved by extending the antenna.

According to an embodiment of the present disclosure, only one of the first earphone unit 930 and the second earphone unit 940 may be coupled to the headphone unit. One of the earphone units connected to the headphone unit may receive first audio data, which is its own audio data, from the user terminal 950 and second audio data, which is audio data of the earphone unit that is not coupled to the headphone unit.

For example, when only the first earphone unit 930 is coupled to the headphone unit, the first earphone unit 930 may receive audio data to be output by the first headphone unit 910 connected to the first earphone unit and audio data to be output by the second headphone unit 920.

The earphone unit coupled to the headphone unit may receive the first audio data to be output by itself and the second audio data to be output by the opposite headphone unit. The earphone unit may convert the first audio data and the second audio data into an LVDS signal through an LVDS conversion circuit. The converted LVDS signal may be transmitted to the headphone unit coupled to the earphone unit. A signal corresponding to the first audio data among the transmitted LVDS signal may be converted into the first audio data by the LVDS conversion circuit of the headphone unit and may be output through the speaker. A signal corresponding to the second audio data of the LVDS signal may be transmitted to the opposite headphone unit through the headband 901 connected to the headphone unit. The opposite headphone unit may be a headphone unit that is not coupled to the earphone unit. The opposite headphone unit may convert a signal corresponding to the second audio data among the LVDS signal received through the headband 901 into the second audio data and may output the second audio data through the speaker. Even if only one of two earphone units is coupled to the headphone unit, the sound may be output through both headphone units.

For example, when only the first earphone unit 930 is connected to the headphone device, the first earphone unit 930 coupled to the first headphone unit 910 may receive the second audio data, which is the audio data of the second earphone unit 940, in addition to the first audio data, which is the audio data of the first earphone unit 930. The LVDS conversion circuit 933 of the first earphone unit 930 may convert the first audio data and the second audio data into the LVDS signal. The converted LVDS signal may be transmitted to the LVDS conversion circuit 913 of the first headphone unit 910 via the first interface 934 of the first earphone unit 930 and the first interface 914 of the first headphone unit 910. The LVDS conversion circuit 913 may output a signal corresponding to the first audio data among the LVDS signal into the first audio data and may output the first audio data through the speaker. The LVDS conversion circuit 913 may transmit a signal corresponding to the second audio data among the LVDS signal to the LVDS conversion circuit 923 of the second headphone unit 920 via a conducting wire included in the headband 901. The LVDS conversion circuit 923 may convert the signal corresponding to the second audio data among the received LVDS signal into the second audio data and may output the second audio data through the speaker.

In this case, the earphone unit that is not coupled to the headphone unit may be worn by another user other than the headphone user and the user may listen to music. The earphone unit that is not coupled to the headphone unit may be charged using a charging cradle.

When a difference between the batteries of two earphone units occurs because only one of the earphone units performs operations of the audio data received from the user terminal, the roles of the earphone units may be interchanged such that the other earphone unit may receive the audio data and perform operations.

When only one of the earphone units performs operations of the audio data received from the user terminal and the antenna performance is degraded, the roles may be interchanged such that the other earphone unit showing better antenna performance may receive the audio data and perform operations.

When only one of the two earphone units is used by being coupled to the headphone unit and then the other earphone unit is coupled to the headphone unit, the user terminal may transmit the first audio data and the second audio data to both earphone units. In this case, both earphone units may operate the same as the case in which both earphone units are coupled to the headphone unit.

Hereinafter, a description is provided based on the first headphone unit 910 and the first earphone unit 930. Since the description of the first headphone unit 910 is applicable to the second headphone unit 920, the description of the second headphone unit 920 is omitted. In addition, since the description of the first earphone unit 930 is applicable to the second earphone unit 940, the description of the second earphone unit 940 is omitted.

In addition, hereinafter, a flow of data and power when the headphone device 900 includes an additional device, such as the plurality of sensors 1301, is described. Firstly, a flow of data transmission is described.

The first earphone unit 930 may include an LC filter 931, a capacitor 932, a low-voltage differential signaling (LVDS) conversion circuit 933, a first interface 934 (e.g., the interface 312 of FIG. 3), an antenna 935 (e.g., the antenna 602 of FIG. 6A, the antenna 602 of FIG. 6B, the antenna 702 of FIG. 7A, the antenna 702 of FIG. 7B, the antenna 813 of FIG. 8A, and the antenna 813 of FIG. 8B), a communication module 936 (e.g., the communication module 815 of FIG. 8A and the communication module 815 of FIG. 8B), a processor 837, a battery 938, and a plurality of sensors 939. According to an embodiment, the first interface sensor, an acceleration sensor, a hall sensor, and a proximity sensor, but is not limited thereto and may include any device that may collect surrounding information.

The communication module 936 may receive second data including audio data from the user terminal 950 via the antenna 935.

When the first headphone unit 910 includes the Bluetooth antenna 1306, the antenna may be extended. For example, when an earphone unit cover part (e.g., the earphone unit cover part 306 of FIG. 3 and the earphone unit cover part 403 of FIG. 4) of the first headphone unit 910 includes an antenna (e.g., the antenna 704 of FIG. 7A and the antenna 704 of FIG. 7B) and the earphone unit cover part?? is connected to an external contact (e.g., the external contact 706 of FIG. 7B, the external contact 812 of FIG. 8A, and the external contact 812 of FIG. 8B) of the first earphone unit via an antenna contact (e.g., the antenna contact 705 of FIG. 7A and the antenna contact 705 of FIG. 7B), the antenna may be extended. Alternatively, a cradle unit cover part (e.g., the cradle unit cover part 513 of FIG. 5) of a cradle unit (e.g., the cradle unit 511 of FIG. 5) may include a Bluetooth antenna and when the cradle unit cover part??? is connected to the external contact of the first earphone unit, the antenna may be extended.

The first earphone unit 930 may collect third data using a microphone 962 or the plurality of sensors 939. For example, the first earphone unit 930 may collect external sound data via the microphone 962.

The processor 937 may include at least one or a combination of two or more of an MCU and a DSP. The processor 937 may integrate and process the second data and the third data. Original data, which includes general purpose input/output (GPIO), integrated interchip sound (I2S), or I2S/time division multiplexing (TDM) and is generated by being processed through the processor 937, may be transmitted to the LVDS conversion circuit 933 of the first earphone unit 930.

The LVDS conversion circuit 933 of the first earphone unit 930 may convert a signal of the received original data into an LVDS signal by multiplexing. The LVDS conversion circuit 933 of the first earphone unit 930 may transmit the LVDS signal to an LVDS conversion circuit 913 of the first headphone unit 910 through bidirectional one-channel two-lines. The bidirectional one-channel two-line may connect the first earphone unit 930 to the first headphone unit 910 via the first interface 934 of the first earphone unit 930 and a first interface 914 of the first headphone unit. The transmission of the LVDS signal is described with reference to FIGS. 11 and 12.

The communication between the headphone device 900 and the earphone unit may use LVDS communication capable of power and data communication. The LVDS communication may transmit data at a bandwidth of more than a few Mbps.

The capacitor 912 may be connected in series to two lines on a first headphone unit 910 side. The capacitor 932 may be connected in series to two lines on a first earphone unit 930 side. The capacitor 912 may be an alternating current (AC) coupling capacitor and may block a direct current (DC) component input to the LVDS conversion circuit 913 of the first headphone unit 910. The capacitor 932 may be an AC coupling capacitor and may block a DC component input to the LVDS conversion circuit 933 of the first earphone unit 930.

The first headphone unit 910 may include the LC filter 911, the capacitor 912, the LVDS conversion circuit 913, the first interface 914 (e.g., the interface 401 of FIG. 4 and the interface 501 of FIG. 5), a digital-to-analog converter (DAC) 915, an AMP 916, a speaker, a second interface (e.g., a USB-C terminal 918), a battery 917, and a charger 919. According to an embodiment, the first interface 914 may include a pogo pin.

The LVDS conversion circuit 913 of the first headphone unit 910 may convert the received LVDS signal into the original data, which is the data before being converted. The DAC 915 (e.g., the DAC 250 of FIG. 2) may convert audio data included in the original data into an analog signal. The AMP 916 may receive and amplify the analog signal from the DAC 915. The speaker may output the signal amplified by the AMP 916 as sound.

The first headphone unit 910 may include the plurality of sensors 1301. The first headphone unit 910 may further include a switch, a touchpad, or an LED. For example, the first headphone unit 910 may include a switch, a button, or a touchpad for receiving a specific command from a user.

The first headphone unit 910 may include the plurality of microphones 1302. The first headphone unit 910 may include the ADC 1303 connected to the plurality of microphones 1302. An analog signal input by the plurality of microphones 1302 may be converted into a digital signal through the ADC 1303.

The first headphone unit 910 may include the processor 1304 configured to process data. The processor 1304 may include at least one or a combination of two or more of a DSP and an MCU. The processor 1304 may be connected to the ADC 1303, the plurality of sensors 1301, and the LVDS conversion circuit 913. The processor 1304 may receive data from the ADC 1303, the plurality of sensors 1301, and the LVDS conversion circuit 913 and may integrate the data.

The first headphone unit 910 may include the multiplexer 1305. The multiplexer 1305 may be connected to the LVDS conversion circuit 913 and a USB audio interface 1307. When the first headphone unit 910 includes the processor 1304, the multiplexer 1305 may be connected to the processor 1304. The multiplexer 1305 may select at least one from the processor 1304, the USB audio interface 1307, and the LVDS conversion circuit 913 to receive a signal therefrom. The multiplexer 1305 may be connected to the DAC 915 and may transmit a selected signal to the DAC 915.

Hereinafter, a flow of power transmission is described.

The headphone device 900 may receive power from an external power source via a second interface that may be connected to the outside. The second interface may include a USB. For example, the second interface may be a USB-C terminal, a 5-pin terminal, or an 8-pin terminal. Hereinafter, a description is provided based on an assumption that the headphone device 900 includes a USB-C terminal 918.

The USB-C terminal 918 may be connected to an external power source. When the USB-C terminal 918 is connected to the external power source, the headphone device 900 may receive power from the external power source. The received power may be stored in the battery 917 through the charger 919. The power stored in the battery 917 may be used to operate the headphone device 900. For example, the power stored in the battery 917 may be supplied to the LVDS conversion circuit 913, the DAC 915, and/or the AMP 916 of the first headphone unit 910. In addition, the power stored in the battery 917 may be supplied to components included in the second headphone unit 920 from the first headphone unit 910 through a power line (e.g., a transmission line, a cable, or an FPCB) included in the headband 901.

In an embodiment, when the first earphone unit 930 is coupled to the first headphone unit 910, the battery 917 of the first headphone unit 910 may charge the battery 938 of the first earphone unit 930 by supplying the stored power to the first earphone unit 930. The charger 919 of the first headphone unit 910 may determine whether the first headphone unit 910 is coupled to the first earphone unit 930. The charger 919 of the first earphone unit 930 may determine whether the first earphone unit 930 is coupled to the first headphone unit 910.

The power supplied from the first headphone unit 910 to the first earphone unit 930 may be stored in the battery 938 of the first earphone unit 930. In this case, the power may be transmitted as one of the two lines is connected to a ground and the other is connected to VBAT. The power may be transmitted to the first earphone unit 930 by passing through a section isolated by the AC coupling capacitors 912 and 932. The power transmitted to the first earphone unit 930 may be connected to the battery 938 of the first earphone unit 930 through the LC filter 931 and an LVDS signal, which is an AC component, may be blocked.

In addition, the power may be transmitted to the second headphone unit 920 through the headband 901 connected to the first headphone unit 910. The second headphone unit 920 may store the transmitted power in a battery included in a second headphone unit 903. According to an embodiment, when the second headphone unit 920 includes a separate battery, the charger 919 of the first headphone unit 910 may directly transmit the power to the second headphone unit 920 via a power line included in the headband 901.

When the second headphone unit 920 is coupled to the second earphone unit 940 like the first headphone unit 910, the second headphone unit 920 may charge the battery of the second earphone unit 940 via the first interface 924 and a first interface 944. When the second earphone unit 940 is coupled to the headphone device 900, a user may use the second earphone unit 940 while charging the second earphone unit 940.

Hereinafter, operations of an earphone unit and headphones are described using a flowchart.

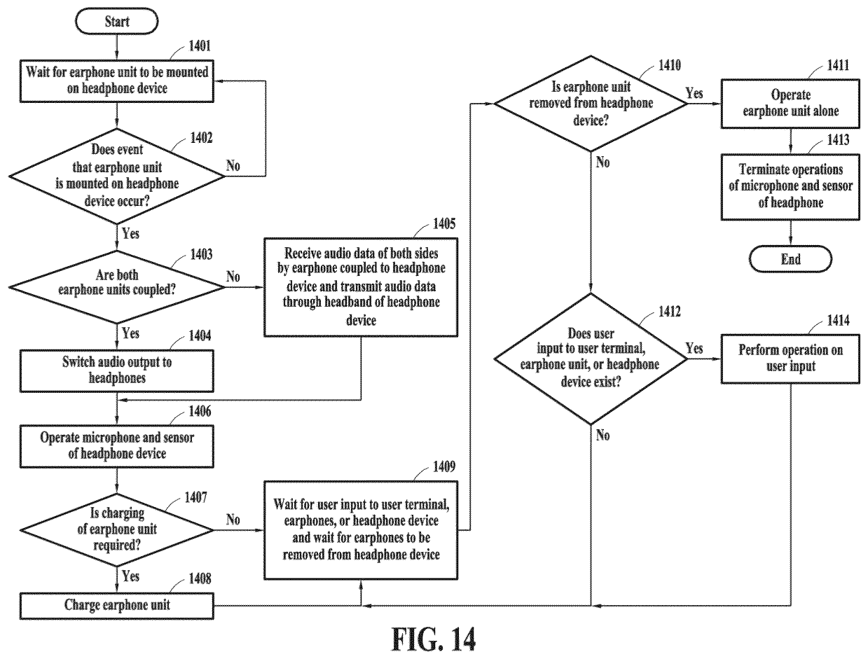

FIG. 14 is a flowchart illustrating headphones that include a plurality of sensors and are coupled to an earphone unit according to an embodiment of the present disclosure.

Operations to be described hereinafter may be sequentially performed but not necessarily. For example, the order of the operations may change, and at least two of the operations may be performed in parallel. Operations 1401 to 1414 may be performed by a headphone device (e.g., the headphone device 300 of FIG. 3 and the headphone device 900 of FIG. 9) and/or an earphone unit (e.g., the earphone unit 601 of FIG. 6A, the earphone unit 601 of FIG. 6B, the earphone unit 701 of FIG. 7A, the earphone unit 701 of FIG. 7B, the earphone unit 810 of FIG. 8A, and the earphone unit 810 of FIG. 8B).

In operation 1401, a headphone device and/or an earphone unit (e.g., the earphone unit 601 of FIG. 6A, the earphone unit 601 of FIG. 6B, the earphone unit 701 of FIG. 7A, the earphone unit 701 of FIG. 7B, the earphone unit 810 of FIG. 8A, and the earphone unit 810 of FIG. 8B) may wait for the earphone unit to be mounted on the headphone device. The headphone device may wait for the earphone unit to be mounted on the headphone device. The earphone unit may wait for the earphone unit to be mounted on the headphone device. For example, the headphone device and the earphone unit may wait for the earphone unit to be mounted on the headphone device and may periodically determine whether the earphone unit is mounted.

In operation 1402, the headphone device and/or the earphone unit may determine whether an event that the earphone unit is mounted on the headphone device occurs. The headphone device may determine whether an event that the earphone unit is mounted on the headphone device occurs. The earphone unit may determine whether an event that the earphone unit is mounted on the headphone device occurs. For example, the headphone device or the earphone unit may determine whether the earphone unit is coupled to the headphone device. The headphone device or the earphone unit may determine whether the earphone unit or a cradle unit (e.g., the cradle unit 511 of FIG. 5) is coupled to an earphone unit coupling portion (e.g., the earphone unit coupling portion 305 of FIG. 3 and the earphone unit coupling portion 402 of FIG. 4) or a cradle unit coupling portion (e.g., the cradle unit coupling portion 502 of FIG. 5) of the headphone unit. In this case, when the earphone unit is not coupled to the headphone device, operation 1401 may be performed. When the earphone unit is coupled to the headphone device, operation 1403 may be performed.

In operation 1403, the headphone device and/or the earphone unit may determine whether both earphone units are coupled. The headphone device or the earphone unit may determine whether both sides of the headphone unit are coupled to both earphone units. When only one of the earphone units is coupled, operation 1405 may be performed. When both earphone units are coupled, operation 1406 may be performed.

In operation 1405, the earphone unit coupled to the headphone device may receive audio data of both earphone units. The audio data, received by the earphone unit, of the earphone unit that is not coupled to the headphone device may be transmitted to the headphone unit that is not coupled to the earphone unit, through the headband. The headphone unit that is not coupled to the earphone unit may receive the audio data through the headband and may output the received audio data. For example, when only the left earphone unit is coupled to the left headphone unit, the audio data of the right earphone unit may be received by the left earphone unit. The audio data of the right earphone may be transmitted to the right headphone unit through the headband. Although the right headphone is not coupled to the earphone unit, the right headphone may output the audio.

In operation 1404, the earphone unit may switch audio output from the earphone unit to the headphone device. For example, when the earphone unit is coupled to the headphone device while outputting audio, the audio may be output from a speaker of the headphone device.

In operation 1406, a microphone (e.g., the plurality of microphones 1302 of FIG. 13) and/or the plurality of sensors (e.g., the plurality of sensors 1301 of FIG. 13) of the headphone device may operate.

In operation 1407, the headphone device and/or the earphone unit may determine whether the earphone unit needs to be charged. The headphone device may determine whether the earphone unit needs to be charged. The earphone unit may determine whether the earphone unit needs to be charged. When charging is needed, operation 1408 may be performed. When charging is not needed, operation 1409 may be performed.

In operation 1408, when charging is needed, the earphone unit may be charged. For example, when charging is needed, the headphone device may charge a battery (e.g., the battery 938 of FIG. 9) of the earphone unit using the power stored in a battery (e.g., the battery 917 of FIG. 9).

In operation 1409, the headphone device or the earphone unit may wait for a user input to the earphone unit or the headphone device or removal of the earphone unit from the headphone device. The headphone device may wait for a user input to a user terminal, the earphone unit, or the headphone device or removal of the earphone unit from the headphone device. The earphone unit may wait for a user input to a user terminal, the earphone unit, or the headphone device or removal of the earphone unit from the headphone device.

In operation 1410, the headphone device and/or the earphone unit may determine whether the earphone unit is removed from the headphone device. The headphone device may determine whether the earphone unit is removed from the headphone device. The earphone unit may determine whether the earphone unit is removed from the headphone device. When the earphone unit is removed from the headphone device, operation 1411 may be performed. When the earphone unit is not removed from the headphone device, operation 1412 may be performed.

In operation 1411, when the earphone unit is removed from the headphone device, the earphone unit may operate alone. For example, when the earphone unit is removed from the headphone device while the headphones are outputting audio, only the earphone unit may output the audio.

In operation 1413, the operation of the microphone and/or the plurality of sensors of the headphone device may be terminated.

In operation 1412, the headphone device or the earphone unit may determine whether a user input to the user terminal, the earphone unit, or the headphone device exists. The headphone device may determine whether a user input to the user terminal, the earphone unit, or the headphone device exists. The earphone unit may determine whether a user input to the user terminal, the earphone unit, or the headphone device exists. When a user input to the user terminal, the earphone unit, or the headphone device exists, operation 1414 may be performed. When the user input to the user terminal, the earphone unit, or the headphone device does not exist, operation 1409 may be performed.

In operation 1414, when the user input to the user terminal, the earphone unit, or the headphone device exists, the headphone device or the earphone unit may perform an operation on the user input. For example, when the user performs an operation of decreasing a volume level of an audio output, the headphone device and the earphone unit may decrease the volume level of the audio output. When the user performs an operation of pausing the audio output, the headphone device and the earphone unit may pause the audio output. After the headphone device or the earphone unit performs the operation on the user input, operation 1409 may be performed.

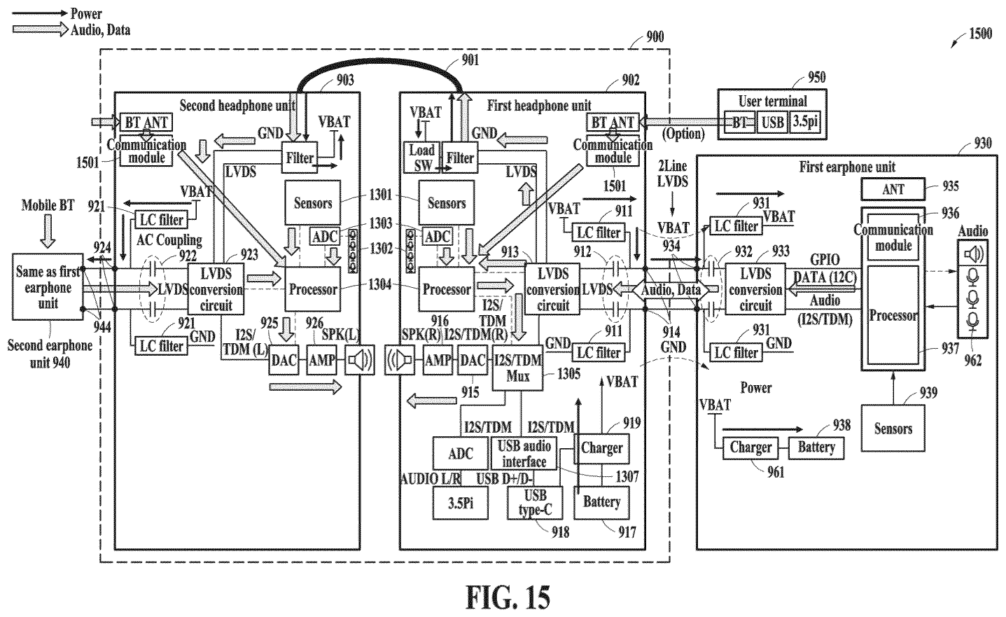

FIG. 15 is a block diagram 1500 illustrating headphones including a plurality of Bluetooth ICs and coupled to an earphone unit according to an embodiment of the present disclosure.

Referring to FIG. 15, the headphone device 900 (e.g., the headphone device 300 of FIG. 3), an earphone unit (e.g., the earphone unit 501 of FIG. 6A, the earphone unit 501 of FIG. 6B, the earphone unit 701 of FIG. 7A, and the earphone unit 701 of FIG. 7B), and the user terminal 950 are illustrated.

The headphone device may include a headband 901 (e.g., the headband 301 of FIG. 3), a first headphone unit 910 (e.g., the first headphone unit 302 of FIG. 3) connected to an end of the headband 901, and a second headphone unit 920 (e.g., the second headphone unit 303 of FIG. 3) connected to the other end of the headband 901. The second headphone unit 920 may be electrically connected to the first headphone unit 910 through the headband 901.

The first headphone unit 910 may include the LC filter 911, the capacitor 912, the LVDS conversion circuit 913, the first interface 914 (e.g., the interface 401 of FIG. 4 and the interface 501 of FIG. 5), a digital-to-analog converter (DAC) 915, an AMP 916, a speaker, a second interface (e.g., a USB-C terminal 918), a battery 917, and a charger 919. According to an embodiment, the first interface 914 may include a pogo pin.

Referring to FIG. 15, the first headphone unit 910 and the second headphone unit 920 may include at least one or a combination of two or more of a plurality of sensors 1301, a plurality of microphones 1302, an ADC 1303 (e.g., the ADC 230 of FIG. 2), a processor 1304, a multiplexer 1305, and a Bluetooth antenna 1306.

The earphones (e.g., the earphones 314 of FIG. 3) may include the first earphone unit 930 (e.g., the first earphone unit 310 of FIG. 3) and the second earphone unit 940 (e.g., the second earphone unit 311 of FIG. 3).

The user terminal 950 may be a terminal that may communicate with the earphone unit or the headphone device wirelessly or by wire. The user terminal 950 may communicate with the earphone unit or the headphone device by wire via a USB terminal or a 3.5 pi terminal. The user terminal 950 may communicate with the earphone unit or the headphone device wirelessly via a Bluetooth IC.

According to an embodiment, the user terminal 950 may include various computing devices, such as a mobile phone, a smartphone, a tablet PC, an e-book device, a laptop, a PC, a desktop, a workstation, or a server, various wearable devices, such as a smartwatch, smart eyeglasses, an HMD, or smart clothing, various home appliances such as a smart speaker, a smart TV, or a smart refrigerator, and other devices, such as a smart vehicle, a smart kiosk, an IoT device, a WAD, a drone, or a robot.

Hereinafter, a description is provided based on the first headphone unit 910 and the first earphone unit 930. Since the description of the first headphone unit 910 is applicable to the second headphone unit 920, the description of the second headphone unit 920 is omitted. In addition, since the description of the first earphone unit 930 is applicable to the second earphone unit 940, the description of the second earphone unit 940 is omitted.

According to an embodiment of the present disclosure, the headphone device 900 may further include a communication module 1501. Referring to FIG. 15, the first headphone unit 910 and the second headphone unit 920 may include the communication module 1501. The communication module 1501 may support Bluetooth and/or BLE. However, a communication protocol supported by the communication module 1501 is not limited to Bluetooth or BLE.

When the headphone device 900 includes the communication module 1501, the headphone device 900 may directly receive audio data from the user terminal 950. The headphone device 900 may be used alone without being coupled to the earphone unit. The headphone device 900 may be paired with the user terminal 950 alone.

When the standalone usable headphone 900 is coupled to the earphone unit, data collected by the microphone 962 or the plurality of sensors 939 included in the earphone unit may be transmitted to the headphone device 900. When the standalone usable headphone device 900 is coupled to the earphone unit, a battery of the earphone unit may be charged.

According to an embodiment, the headphone device 900 may be connected to a first user terminal and the earphone unit may be connected to a second user terminal. For example, the headphone device 900 may be connected to the first user terminal via the communication module 1501 of the headphone device 900 and the earphone unit (e.g., the first earphone unit 930) may be connected to the second user terminal via the communication module 936.

According to an embodiment, when the headphone device 900 is coupled to the earphone unit while the headphone device 900 is connected to the first user terminal and the earphone unit is connected to the second user, a battery (e.g., the battery 938) of the earphone unit may be charged and the headphone device 900 may receive audio data from the first user terminal that is previously connected and may output the audio data.

According to an embodiment, when the headphone device 900 is coupled to the earphone unit while the headphone device 900 is connected to the first user terminal and the earphone unit is connected to the second user, a battery (e.g., the battery 938) of the earphone unit may be charged and the headphone device 900 may receive audio data from the second user terminal connected to the earphone unit and may output the audio data. The headphone device 900 may continuously output the audio that the earphone unit is outputting.

Hereinafter, a flow of data and power when the headphone device includes the communication module 1501 and an additional device such as the plurality of sensors 1301 is described. Firstly, a flow of data transmission is described.

The first headphone unit 910 may directly receive data from the user terminal 950 via the communication module 1501. The communication module 1501 may transmit the data received from the user terminal 950 to the processor 1304.

The processor 1304 may include at least one or a combination of two or more of a DSP and an MCU. The processor 1304 may be connected to the ADC 1303, the plurality of sensors 1301, the LVDS conversion circuit 913, the multiplexer 1305, and the communication module 1501. The processor 1304 may receive data from the ADC 1303, the plurality of sensors 1301, the LVDS conversion circuit 913, the multiplexer 1305, and the communication module 1501 and may integrate the data.

The first headphone unit 910 may include the plurality of sensors 1301. The first headphone unit 910 may further include a switch, a touchpad, and/or an LED. For example, the first headphone unit 910 may include a switch, a button, or a touchpad for receiving a specific command from a user.

The first headphone unit 910 may include the plurality of microphones 1302. The first headphone unit may include the ADC 1303 connected to the plurality of microphones 1302. An analog signal input by the plurality of microphones may be converted into a digital signal through the ADC 1303.

The first headphone unit 910 may include the multiplexer 1305. The multiplexer 1305 may be connected to the LVDS conversion circuit 913 and a USB audio interface 1307. When the first headphone unit 910 includes the processor 1304, the multiplexer 1305 may be connected to the processor 1304. The multiplexer 1305 may select one from the processor 1304, the USB audio interface 1307, and the LVDS conversion circuit 913 to receive a signal therefrom. The multiplexer 1305 may be connected to the DAC 915 and may transmit a selected signal to the DAC 915.

Even if the first headphone unit 910 directly communicates with the user terminal 950 via the communication module 1501, the first headphone unit 910 may be coupled to the first earphone unit 930. In this case, since the first headphone unit 910 may receive data for an audio output directly from the user terminal 950 via the communication module 1501, the first headphone unit 910 may receive data collected by the microphone 962 and/or the plurality of sensors 939 included in the first earphone unit 930.

According to an embodiment, the LVDS conversion circuit 933 of the first earphone unit 930 may convert signals of the data collected by the microphone 962 and/or the plurality of sensors 939 into LVDS signals by multiplexing. The LVDS conversion circuit 933 of the first earphone unit 930 may transmit the LVDS signal to an LVDS conversion circuit 913 of the first headphone unit 910 at high speed through bidirectional one-channel two-lines. The bidirectional one-channel two-line may connect the first earphone unit 930 to the first headphone unit 910 via the first interface 934 of the first earphone unit 930 and a first interface 914 of the first headphone unit. The transmission of the LVDS signal is described with reference to FIGS. 11 and 12.

The communication between the headphone device 900 and the earphone unit may use LVDS communication capable of power and data communication. The LVDS communication may transmit data at a bandwidth of more than a few Mbps.

The capacitor 912 may be connected in series to two lines on a first headphone unit 910 side. The capacitor 932 may be connected in series to two lines on a first earphone unit 930 side. The capacitor 912 may be an alternating current (AC) coupling capacitor and may block a direct current (DC) component input to the LVDS conversion circuit 913 of the first headphone unit 910. The capacitor 932 may be an AC coupling capacitor and may block a DC component input to the LVDS conversion circuit 933 of the first earphone unit 930.

Hereinafter, a flow of power transmission is described.

The headphone device 900 may receive power from an external power source via a second interface that may be connected to the outside. The second interface may be a USB-C terminal, a 5-pin terminal, or an 8-pin terminal. Hereinafter, a description is provided based on an assumption that the headphone device 900 includes a USB-C terminal 918.

The USB-C terminal 918 may be connected to an external power source. When the USB-C terminal 918 is connected to the external power source, the headphone device 900 may receive power from the external power source. The received power may be stored in the battery 917 through the charger 919. The power stored in the battery 917 may be used to operate the headphone device 900. For example, the power stored in the battery 917 may be supplied to the LVDS conversion circuit 913, the DAC 915, and/or the AMP 916 of the first headphone unit 910. In addition, the power stored in the battery 917 may be supplied to components included in the second headphone unit 920 from the first headphone unit 910 through the headband 901.

In an embodiment, when the first earphone unit 930 is coupled to the first headphone unit 910, the battery 917 may charge the battery 938 of the first earphone unit 930 by supplying the stored power to the first earphone unit 930. The charger 919 of the first headphone unit 910 may determine whether the first headphone unit 910 is coupled to the first earphone unit 930. The charger 961 of the first earphone unit 930 may determine whether the first earphone unit 930 is coupled to the first headphone unit.

The provided power may be stored in the battery 938 of the first earphone unit 930. In this case, the power may be transmitted as one of the two lines is connected to a ground and the other is connected to VBAT. The power may be transmitted to the first earphone unit 930 by passing through a section isolated by the AC coupling capacitors 912 and 932. The power transmitted to the first earphone unit 930 may be stored in the battery 938 of the first earphone unit 930 through the LC filter 931. The LVDS signal, which is an AC component, may be blocked by the LC filter 931.

In addition, the power may be transmitted to the second headphone unit 920 through the headband 901 connected to the first headphone unit 910. The second headphone unit 920 may store the transmitted power in a battery included in a second headphone unit 920. According to an embodiment, when the second headphone unit 920 includes a separate battery, the charger 919 of the first headphone unit 910 may directly transmit the power to the second headphone unit 920 via a power line included in the headband 901.

When the second headphone unit 920 is coupled to the second earphone unit 940 like the first headphone unit 910, the second headphone unit 920 may charge a battery of the second earphone unit 940. In an embodiment, when the earphone unit is coupled to the headphone device, the user may use the earphone unit while charging the earphone unit.

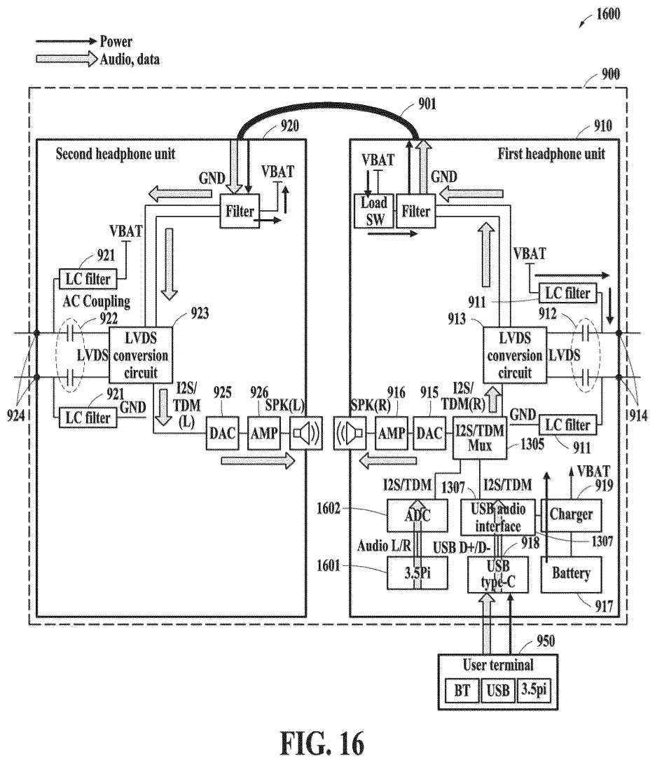

FIG. 16 is a block diagram 1600 illustrating headphones used alone and connected to a user terminal by wire according to an embodiment of the present disclosure.

Referring to FIG. 16, the headphone device 900 (e.g., the headphone device 300 of FIG. 3) and the user terminal 950 are illustrated.

The headphone device 900 may include a headband 901 (e.g., the headband 301 of FIG. 3), a first headphone unit 910 (e.g., the first headphone unit 302 of FIG. 3) connected to an end of the headband 901, and a second headphone unit 920 (e.g., the second headphone unit 303 of FIG. 3) connected to the other end of the headband 901. The second headphone unit 920 may be electrically connected to the first headphone unit 910 through the headband 901.

The user terminal 950 may be a terminal that may communicate by wire or wirelessly with an earphone unit (e.g., the first earphone unit 930 of FIG. 9 or the second earphone unit 940 of FIG. 9) or the headphone device 900. The user terminal 950 may communicate with the earphone unit or the headphone device 900 by wire via a USB terminal or a 3.5 pi terminal. The user terminal 950 may communicate with the earphone unit or the headphone device 900 wirelessly via a Bluetooth IC.

According to an embodiment, the user terminal 950 may include various computing devices, such as a mobile phone, a smartphone, a tablet PC, an e-book device, a laptop, a PC, a desktop, a workstation, or a server, various wearable devices, such as a smartwatch, smart eyeglasses, an HMD, or smart clothing, various home appliances such as a smart speaker, a smart TV, or a smart refrigerator, and other devices, such as a smart vehicle, a smart kiosk, an IoT device, a WAD, a drone, or a robot.

According to an embodiment of the present disclosure, the headphone device 900 may be connected to the user terminal 950 by wire. For example, the headphone device 900 may be connected to the user terminal 950 via a 3.5 pi terminal or a USB-C terminal 918. The headphone device 900 may receive data and power from the user terminal 950 by wire. When the headphone device 900 is connected to the user terminal 950 via the USB-C terminal 918, charging and data transmission may occur simultaneously. In this case, the headphone device 900 may output audio even if the headphone device 900 is not connected to the earphone unit. Since the headphone device 900 may be connected by wire, a communication module (e.g., the communication module 1501 of FIG. 15) and an antenna (e.g., the Bluetooth antenna 1306 of FIG. 13) for wireless communication may not be required.

Hereinafter, a description is provided based on the first headphone unit 910. Since the description of the first headphone unit 910 is applicable to the second headphone unit 920, the description of the second headphone unit 920 is omitted.

In addition, hereinafter, when the headphone device 900 is connected to the user terminal 950 by wire, a flow of data and power is described. Firstly, a flow of data transmission is described.

The first headphone unit 910 may be connected to the user terminal 950 via the USB-C terminal 918. In this case, the first headphone unit 910 may receive the power and data simultaneously from the user terminal 950. The USB audio interface 1307 may be connected to the USB-C terminal 918. The USB audio interface 1307 may convert the received audio data into an I2S/TDM signal.

When the first headphone unit 910 is connected to the user terminal 950 via a 3.5 pi terminal 1601, an ADC 1602 (e.g., the ADC 230 of FIG. 2) may convert an analog audio signal into an I2S/TDM signal.

The first headphone unit 910 may include the multiplexer 1305. The multiplexer 1305 may be connected to the LVDS conversion circuit 913, the USB audio interface 1307, and the ADC 1602. The multiplexer 1305 may select one from the ADC 1602, the USB audio interface 1307, and the LVDS conversion circuit 913 to receive a signal therefrom. In addition, the multiplexer 1305 may set sync delay values of both headphone units. The multiplexer 1305 may be connected to the DAC 915 (e.g., the DAC 250 of FIG. 2) to transmit the selected signal to the DAC 915. The DAC 915 may convert audio data included in original data into an analog signal. The AMP 916 may receive and amplify the analog signal from the DAC 915. The speaker may output the signal amplified by the AMP 916 as sound.

The first headphone unit 910 may transmit, to the second headphone unit 920, the audio data of the second headphone unit 920 received from the user terminal 950 through the headband 901. The LVDS conversion circuit 913 may transmit the audio data of the second headphone unit 920 received from the user terminal 950 to the second headphone unit 920 through the LVDS signal.

Hereinafter, a flow of power transmission is described.

The first headphone unit 910 may be connected to an external power source via the USB-C terminal 918. The external power source may be the user terminal 950 in addition to a charger. For example, when a desktop is connected to the headphone device by wire, the headphone device may be charged by receiving the power from the desktop.

The power supplied from the user terminal 950 may be stored in the battery 917 through the charger 919. The power stored in the battery 917 may be used to operate the headphone device 900. For example, the power stored in the battery 917 may be supplied to the LVDS conversion circuit 913, the DAC 915, and/or the AMP 916 of the first headphone unit 910. In addition, the power stored in the battery 917 may be supplied to the second headphone unit 920 from the first headphone unit 910 through the headband 901. When the first headphone unit is coupled to the earphone unit (e.g., the first earphone unit 930 of FIG. 9), the earphone unit may be charged.

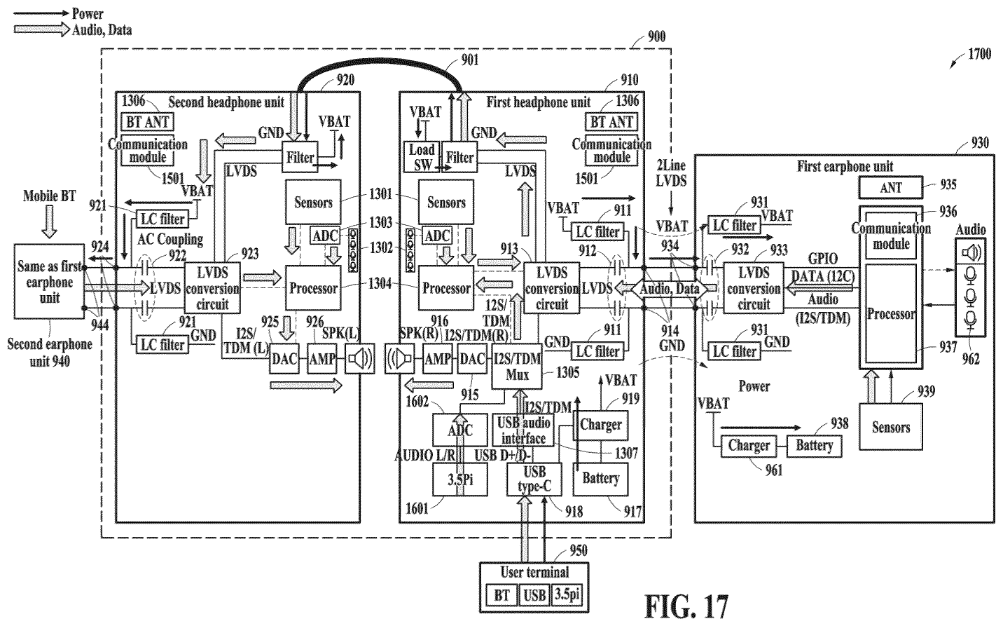

FIG. 17 is a block diagram 1700 illustrating headphones connected to a user terminal by wire and used according to an embodiment of the present disclosure.

Referring to FIG. 17, the headphone device 900 (e.g., the headphone device 300 of FIG. 3), an earphone unit (e.g., the earphone unit 601 of FIG. 6A, the earphone unit 601 of FIG. 6B, the earphone unit 701 of FIG. 7A, and the earphone unit 701 of FIG. 7B), and the user terminal 950 are illustrated.

The headphone device 900 may include the headband 901 (e.g., the headband 301 of FIG. 3), the first headphone unit 910 (e.g., the first headphone unit 302 of FIG. 3) connected to an end of the headband 901, and the second headphone unit 920 (e.g., the second headphone unit 303 of FIG. 3) connected to the other end of the headband 901. The second headphone unit 920 may be electrically connected to the first headphone unit 910 through the headband 901.

The first headphone unit 910 may include the LC filter 911, the capacitor 912, the LVDS conversion circuit 913, the first interface 914 (e.g., the interface 401 of FIG. 4 and the interface 501 of FIG. 5), the DAC 915, the AMP 916, a speaker, a second interface (e.g., the USB-C terminal 918), the battery 917, and the charger 919. According to an embodiment, the first interface 914 may include a pogo pin.

Referring to FIG. 17, the first headphone unit 910 and the second headphone unit 920 may include at least one or a combination of two or more of the plurality of sensors 1301, the plurality of microphones 1302, the ADC 1303 (e.g., the ADC 230 of FIG. 2), the processor 1304, the multiplexer 1305, the Bluetooth antenna 1306, and the communication module 1501.

The earphone unit may be one or more of the first earphone unit 930 (e.g., the first earphone unit 310 of FIG. 3) and the second earphone unit 940 (e.g., the second earphone unit 311 of FIG. 3).

The user terminal 950 may be a terminal that may communicate with the earphone unit or the headphone device 900 wirelessly or by wire. The user terminal 950 may communicate with the unit or the headphone device 900 by wire via a USB terminal or a 3.5 pi terminal. The user terminal 950 may communicate with the earphone unit or the headphone device 900 wirelessly via a Bluetooth IC.

According to an embodiment, the user terminal 950 may include various computing devices, such as a mobile phone, a smartphone, a tablet PC, an e-book device, a laptop, a PC, a desktop, a workstation, or a server, various wearable devices, such as a smartwatch, smart eyeglasses, an HMD, or smart clothing, various home appliances such as a smart speaker, a smart TV, or a smart refrigerator, and other devices, such as a smart vehicle, a smart kiosk, an IoT device, a WAD, a drone, or a robot.

According to an embodiment of the present disclosure, the headphone device 900 may be connected to the user terminal 950 by wire. When the headphone device 900 is connected to the user terminal 950 by wire, the headphone device 900 may receive data and power simultaneously from the user terminal 950. When the earphone unit is coupled to the headphone device 900, the headphone device 900 may provide the power to the earphone unit and may receive the data collected by the microphone 962 and the plurality of sensors 939 from the earphone unit.

Hereinafter, a description is provided based on the first headphone unit 910 and the first earphone unit 930. Since the description of the first headphone unit 910 is applicable to the second headphone unit 920, the description of the second headphone unit 920 is omitted. In addition, since the description of the first earphone unit 930 is applicable to the second earphone unit 940, the description of the second earphone unit 940 is omitted.

In addition, hereinafter, a flow of data and power when the headphone device 900 is connected to the user terminal 950 by wire and is coupled to the earphone unit is described. Firstly, a flow of data transmission is described.

The first headphone unit 910 may be connected to the user terminal 950 via the USB-C terminal 918. In this case, the first headphone unit 910 may receive the power and data simultaneously from the user terminal 950. The USB audio interface 1307 may be connected to the USB-C terminal 918. The USB audio interface 1307 may convert the received audio data into an I2S/TDM signal.

When the first headphone unit 910 is connected to the user terminal 950 via the 3.5 pi terminal 1601, the ADC 1602 (e.g., the ADC 230 of FIG. 2) may convert an analog audio signal into an I2S/TDM signal.

The first headphone unit 910 may include the multiplexer 1305 connected to the USB audio interface 1307. The multiplexer 1305 may be connected to the LVDS conversion circuit 913, the USB audio interface, the processor 1307, and the ADC 1602. The multiplexer 1305 may select one from the processor 1304, the ADC 1605, the USB audio interface 1307, and the LVDS conversion circuit 913 to receive a signal therefrom. In addition, the multiplexer 1305 may set sync delay values of both headphone units. The multiplexer 1305 may be connected to the DAC 915 (e.g., the DAC 250 of FIG. 2) to transmit the selected signal to the DAC 915. The DAC 915 may convert audio data included in original data into an analog signal. The AMP 916 may receive and amplify the analog signal from the DAC 915. The speaker may output the signal amplified by the AMP 916 as sound.

The first headphone unit 910 may transmit, to the second headphone unit 920, the audio data of the second headphone unit 920 received from the user terminal 950 through the headband 901. The LVDS conversion circuit 913 may transmit the audio data of the second headphone unit 920 received from the user terminal 950 to the second headphone unit 920 through the LVDS signal.

The processor 1304 may include at least one or a combination of two or more of a DSP and an MCU. The processor 1304 may be connected to the ADC 1303, the plurality of sensors 1301, the multiplexer 1305, and the LVDS conversion circuit 913. The processor 1304 may receive data from the ADC 1303, the plurality of sensors 1301, and the LVDS conversion circuit 913 and may integrate the data.

The first headphone unit 910 may include the plurality of sensors 1301. The first headphone unit 910 may further include a switch, a button, a touchpad, and/or an LED. For example, the first headphone unit 910 may further include a switch and a touchpad for receiving a specific command from a user. The data collected by the plurality of sensors 1301 may be processed by the processor 1304.

The first headphone unit 910 may include the plurality of microphones 1302. The first headphone unit 920 may include the ADC 1303 connected to the plurality of microphones 1302. An analog signal input by the plurality of microphones 1302 may be converted into a digital signal through the ADC 1303. The digital signal converted by the ADC 1303 may be processed by the processor 1304.

The first headphone unit 910 may be coupled to the first earphone unit 930 while being connected to the user terminal 950 by wire. In this case, since the first headphone unit 910 may receive the data directly from the user terminal 950 through wire connection, the first headphone unit 910 may receive, from the first earphone unit 930, only the data collected by the microphone 962 or the plurality of sensors 939 included in the first earphone unit 930.

According to an embodiment, the LVDS conversion circuit 933 of the first earphone unit 930 may convert signals of the data collected by the microphone 962 or the plurality of sensors 939 into LVDS signals by multiplexing. The LVDS conversion circuit 933 of the first earphone unit 930 may transmit the LVDS signal to an LVDS conversion circuit 913 of the first headphone unit 910 at high speed through bidirectional one-channel two-lines. The bidirectional one-channel two-line may connect the first earphone unit 930 to the first headphone unit 910 via the first interface 934 of the first earphone unit 930 and a first interface 914 of the first headphone unit. The transmission of the LVDS signal is described with reference to FIGS. 11 and 12.

The communication between the headphone device 900 and the earphone unit may use LVDS communication capable of power and data communication. The LVDS communication may transmit data at a bandwidth of more than a few Mbps.

The capacitor 912 may be connected in series to two lines on a first headphone unit 910 side. The capacitor 932 may be connected in series to two lines on a first earphone unit 930 side. The capacitor 912 may be an alternating current (AC) coupling capacitor and may block a direct current (DC) component input to the LVDS conversion circuit 913 of the first headphone unit 910. The capacitor 932 may be an AC coupling capacitor and may block a DC component input to the LVDS conversion circuit 933 of the first earphone unit 930.

Hereinafter, a flow of power transmission is described.

The first headphone unit 910 may be connected to an external power source via the USB-C terminal 918. The external power source may be the user terminal 950 in addition to a charger. For example, when a desktop is connected to the headphone device 900 by wire, the headphone device 900 may be charged by receiving the power from the desktop.

The power supplied from the user terminal 950 may be stored in the battery 917. The power stored in the battery 917 may be used to operate the headphone device 900. For example, the power stored in the battery 917 may be supplied to the LVDS conversion circuit 913, the DAC 915, and/or the AMP 916 of the first headphone unit 910. In addition, the power stored in the battery 917 may be supplied to components included in the second headphone unit 920 from the first headphone unit 910 through the headband 901. When the headphone unit is coupled to the earphone unit, the earphone unit may be charged.

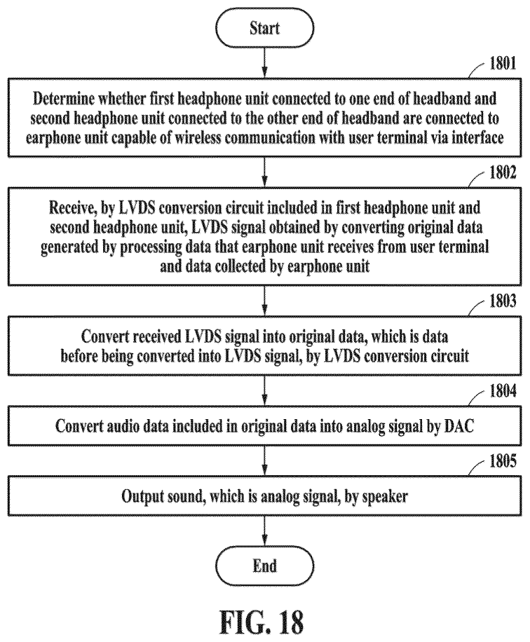

FIG. 18 is a flowchart illustrating an operating method of a headphone device according to an embodiment of the present disclosure.

Operations to be described hereinafter may be sequentially performed but not necessarily. For example, the order of the operations may change, and at least two of the operations may be performed in parallel. Operations 1801 and 1802 may be performed by a headphone device (e.g., the electronic device 101 of FIG. 1, the headphone device 300 of FIG. 3, and the headphone device 900 of FIG. 9).

In operation 1801, the headphone device may determine whether a first headphone unit (e.g., the first headphone unit 302 of FIG. 3 and the first headphone unit 910 of FIG. 9) connected to an end of a headband (e.g., the headband 301 of FIG. 3 and the headband 901 of FIG. 9) and a second headphone unit (e.g., the second headphone unit 303 of FIG. 3 and the second headphone unit 920 of FIG. 9) connected to the other end of the headband are connected to an earphone unit (e.g., the first earphone unit 310 of FIG. 3, the second earphone unit 311 of FIG. 3, the earphone unit 601 of FIG. 6A, the earphone unit 601 of FIG. 6B, the earphone unit 701 of FIG. 7A, the earphone unit 701 of FIG. 7B, the earphone unit 810 of FIG. 8A, the earphone unit 810 of FIG. 8B, the first earphone unit 930 of FIG. 9 and the second earphone unit 940 of FIG. 9) capable of wireless communication with a user terminal (e.g., the user terminal 950 of FIG. 9) via an interface (e.g., the interface 305 of FIG. 3, the interface 401 of FIG. 4, the interface 501 of FIG. 5, the interface 801 of FIG. 8A, the interface 801 of FIG. 8B, the first interface 914 of FIG. 9, and the first interface 924 of FIG. 9).

In operation 1802, an LVDS conversion circuit (e.g., the LVDS conversion circuit 913 of FIG. 9 and the LVDS conversion circuit 923 of FIG. 9) included in the first headphone unit and the second headphone unit may receive an LVDS signal, which is a signal obtained by converting original data generated by processing data that the earphone unit receives from the user terminal or data collected by the earphone unit.

In operation 1803, the LVDS conversion circuit may convert the received LVDS signal into the original data, which is the data before being converted into the LVDS signal.

In operation 1804, a DAC (e.g., the DAC 250 of FIG. 2 and the DAC 915 of FIG. 9) may convert audio data included in the original data into an analog signal.

In operation 1805, a speaker may output sound, which is the analog signal.

The above descriptions provided with reference to FIGS. 1 to 17 may apply to the operations illustrated in FIG. 18, and thus further detailed descriptions thereof are omitted.

According to an embodiment, a headphone device (e.g., the electronic device 101 of FIG. 1, the headphone device 300 of FIG. 3, and the headphone device 900 of FIG. 9) may include a headband (e.g., the headband 301 of FIG. 3 and the headband 901 of FIG. 9). The headphone device may include a first headphone unit (e.g., the first headphone unit 302 of FIG. 3 and the first headphone unit 910 of FIG. 9) connected to an end of the headband. The headphone device may include a second headphone unit (e.g., the second headphone unit 303 of FIG. 3 and the second headphone unit 920 of FIG. 9) connected to the other end of the headband electrically connected to the first headphone unit through the headband. The first headphone unit and the second headphone unit may include an interface (e.g., the interface 305 of FIG. 3, the interface 401 of FIG. 4, the interface 501 of FIG. 5, the interface 801 of FIG. 8A, the interface 801 of FIG. 8B, the first interface 914 of FIG. 9, and the first interface 924 of FIG. 9) connected to an interface (e.g., the interface 312 of FIG. 3, the interface 313 of FIG. 3, the interface 811 of FIG. 8A, the interface 811 of FIG. 8B, the first interface 934 of FIG. 9, the first interface 944 of FIG. 9) of an earphone unit (e.g., the first earphone unit 310 of FIG. 3, the second earphone unit 311 of FIG. 3, the earphone unit 601 of FIG. 6A, the earphone unit 601 of FIG. 6B, the earphone unit 701 of FIG. 7A, the earphone unit 701 of FIG. 7B, the earphone unit 810 of FIG. 8A, the earphone unit 810 of FIG. 8B, the first earphone unit 930 of FIG. 9, and the second earphone unit 940 of FIG. 9) that is capable of wireless communication with a user terminal (e.g., the user terminal 950 of FIG. 9). The first headphone unit and the second headphone unit may include an LVDS conversion circuit (e.g., the LVDS conversion circuit 913 of FIG. 9 and the LVDS conversion circuit 923 of FIG. 9) configured to receive, through an interface, an LVDS signal, which is a signal obtained by converting original data generated by processing data that the earphone unit receives from the user terminal and data collected by the earphone unit and convert the received LVDS signal into the original data, which is the data before being converted into the LVDS signal. The first headphone unit and the second headphone unit may include a DAC (e.g., the DAC 250 of FIG. 2 and the DAC 915 of FIG. 9) configured to convert audio data included in the original data into an analog signal. The first headphone unit and the second headphone unit may include a speaker configured to output sound, which is the analog signal.

According to an embodiment, the first headphone unit and the second headphone unit may further include an earphone unit coupling portion (e.g., the earphone unit coupling portion 304 of FIG. 3 and the earphone unit coupling portion 402 of FIG. 4) coupled to an earphone unit in which an interface is disposed. When the earphone unit coupling portion is coupled to the earphone unit via the interface disposed therein, the first headphone unit and the second headphone unit may include an earphone unit cover part (e.g., the earphone unit cover part 306 of FIG. 3, the earphone unit cover part 403 of FIG. 4, the earphone unit cover part 603 of FIG. 6A, the earphone unit cover part 603 of FIG. 6B, the earphone unit cover part 703 of FIG. 7A, the earphone unit cover part 703 of FIG. 7B) that covers and supports the earphone unit.

According to an embodiment, the earphone unit cover part may include an antenna (e.g., the antenna 704 of FIG. 7A, the antenna 704 of FIG. 7B, and the Bluetooth antenna 1306 of FIG. 13). The earphone unit cover part may include an antenna contact (e.g., the antenna contact 705 of FIG. 7A, the antenna contact 705 of FIG. 7B, the antenna contact 802 of FIG. 8A, and the antenna contact 802 of FIG. 8B) connected to an end of the antenna. The antenna of the earphone unit cover part may be electrically connected to an external contact (e.g., the external contact 706 of FIG. 7B and the external contact 812 of FIG. 8) connected to an end of the antenna (e.g., the antenna 602 of FIG. 6A, the antenna 602 of FIG. 6B, the antenna 702 of FIG. 7A, the antenna 702 of FIG. 7B, and the antenna 935 of FIG. 9) included in the earphone unit via the antenna contact.

According to an embodiment, the first headphone unit and the second headphone unit may include a cradle unit coupling portion (e.g., the cradle unit coupling portion 502 of FIG. 5) which is coupled to a cradle unit (e.g., the cradle unit 511 of FIG. 5) and in which an interface electrically connected to the cradle unit coupled to the earphone unit. The first headphone unit and the second headphone unit may further include a fastening hook (e.g., the hook 503 of FIG. 5) to prevent the cradle unit from being separated from the cradle unit coupling portion.

According to an embodiment, the cradle unit may include a first surface coupled to the earphone unit. The cradle unit may include a second surface coupled to the cradle unit coupling portion. The cradle unit may include a cradle unit cover part (e.g., the cradle unit cover part 513 of FIG. 5, the earphone unit cover part 603 of FIG. 6A, the earphone unit cover part 603 of FIG. 6B, the earphone unit cover part 703 of FIG. 7A, and the earphone unit cover part 703 of FIG. 7B) that supports the earphone unit. When the shape of the earphone unit is different, the shape of the first surface may be different. Even when the shape of the earphone unit is different, the shape of the second surface may be the same.

According to an embodiment, the cradle unit cover part may include an antenna (e.g., the antenna 704 of FIG. 7A, the antenna 704 of FIG. 7B, and the Bluetooth antenna 1306 of FIG. 13). The cradle unit cover part may include an antenna contact (e.g., the antenna contact 705 of FIG. 7A, the antenna contact 705 of FIG. 7B, the antenna contact 802 of FIG. 8A, and the antenna contact 802 of FIG. 8B) connected to an end of an antenna pattern. An external contact (e.g., the external contact 706 of FIG. 7B, the external contact 812 of FIG. 8A, and the external contact 812 of FIG. 8B) connected to an end of the antenna pattern of the earphone unit may be electrically connected to the antenna contact of the cradle unit cover part.

According to an embodiment, the first headphone unit and the second headphone unit may include a headphone battery (e.g., the battery 917 of FIG. 9). The headphone battery may be an example of the battery 189 of FIG. 1. When the first headphone unit and the second headphone unit are connected to the earphone unit via the interface, the battery (e.g., the battery 938 of FIG. 9) of the earphone unit may be charged using power stored in the headphone battery.

According to an embodiment, original data may be data obtained by processing data received from the user terminal through wireless communication and data collected by a plurality of sensors (e.g., the plurality of sensors 939 of FIG. 9) included in the earphone unit.

According to an embodiment, the LVDS conversion circuit may receive an LVDS signal from the earphone unit through a bidirectional channel including a first line and a second line.

In an embodiment, the LVDS signal may be a reverse phase signal and may be a signal transmitted through the first line and the second line. According to an embodiment, the LVDS signal may be a differential signal and may be a signal transmitted through the first line and the second line.

According to an embodiment, the first headphone unit and the second headphone unit may include a capacitor (e.g., the capacitor 912 of FIG. 9 and the capacitor 922 of FIG. 9) that only passes the LVDS signal. The first headphone unit and the second headphone unit may further include an LC filter (e.g., the LC filter 911 of FIG. 9 and the LC filter 921 of FIG. 9) configured to separate an LVDS signal and the power that the headphone battery transmits or receives.

According to an embodiment, when only one of the first headphone unit and the second headphone unit is coupled to the earphone unit, the headphone unit coupled to the earphone unit may transmit a portion of the LVDS signal received from the earphone unit to the headphone unit that is not coupled to the earphone unit, through the headband. The portion of the received LVDS signal may include data to output sound by the headphone unit, which is not coupled to the earphone unit.

According to an embodiment, the first headphone unit and the second headphone unit may include a plurality of sensors (e.g., the plurality of sensors 1301 of FIG. 13). The first headphone unit and the second headphone unit may include a plurality of microphones (e.g., the plurality of microphones 1302 of FIG. 13). The first headphone unit and the second headphone unit may include a processor (e.g., the processor 1304 of FIG. 13) configured to integrate data collected by the plurality of sensors and/or the plurality of microphones with an LVDS signal received from the earphone unit and process the data and the LVDS signal.

According to an embodiment, the first headphone unit and the second headphone unit may include a communication module (e.g., the communication module 1501 of FIG. 15) that directly communicates with the user terminal. The first headphone unit and the second headphone unit may receive the data directly from the user terminal without being coupled to the earphone unit via the communication module.

According to an embodiment, wireless earphones (e.g., the earphones 314 of FIG. 3) may include a first earphone unit (e.g., the first earphone unit 310 of FIG. 3 and the first earphone unit 930 of FIG. 9) coupled to a first headphone unit connected to an end of a headband of a headphone device (e.g., the electronic device 101 of FIG. 1, the headphone device 300 of FIG. 3, and the headphone device 900 of FIG. 9). The wireless earphones may include a second earphone unit (e.g., the second earphone unit 311 of FIG. 3 and the second earphone unit 940 of FIG. 9) coupled to a second headphone unit connected to the other end of the headband electrically connected to the first headphone unit. The first earphone unit and the second earphone unit may include a battery (e.g., the battery 938 of FIG. 9). The first earphone unit and the second earphone unit may include an antenna (e.g., the antenna 602 of FIG. 6A, the antenna 602 of FIG. 6B, the antenna 702 of FIG. 7A, the antenna 702 of FIG. 7B, and the antenna 935 of FIG. 9) configured to wirelessly receive data from a user terminal (e.g., the user terminal 950 of FIG. 9). The first earphone unit and the second earphone unit may include a processor (e.g., the processor 937 of FIG. 9) configured to generate original data by processing the data received from the user terminal and the data collected by the plurality of sensors. The first earphone unit and the second earphone unit may include an interface (e.g., the interface 312 of FIG. 3, the interface 313 of FIG. 3, the interface 811 of FIG. 8A, the interface 811 of FIG. 8B, the first interface 934 of FIG. 9, and the first interface 944 of FIG. 9) connected to a headphone unit (e.g., the first headphone unit 302 of FIG. 3, the second headphone unit 303 of FIG. 3, the headphone unit 800 of FIG. 8A, the headphone unit 800 of FIG. 8B, the first headphone unit 910 of FIG. 9, and the second headphone unit 920 of FIG. 9) of the headphone device. The first earphone unit and the second earphone unit may include an LVDS conversion circuit (e.g., the LVDS conversion circuit 933 of FIG. 9) configured to convert the original data into an LVDS signal via the interface and transmit the converted LVDS signal to the headphone unit of the headphone device.

According to an embodiment, the first earphone unit and the second earphone unit may include a capacitor (e.g., the capacitor 932 of FIG. 9) that only passes the LVDS signal. The first earphone unit and the second earphone unit may include an LC filter (e.g., the LC filter 931 of FIG. 9) configured to separate an LVDS signal and the power received by the battery.

According to an embodiment, when the first earphone unit and the second earphone unit are connected to the first headphone unit and the second headphone unit via the interface, the battery may be charged by receiving the power stored in a headphone battery (e.g., the battery 189 of FIG. 1 and the battery 917 of FIG. 9).

According to an embodiment, the LVDS conversion circuit may transmit an LVDS signal from the wireless earphone unit to the headphone device through a bidirectional channel including a first line and a second line.

According to an embodiment, the LVDS signal may be transmitted through the first line and the second line. The LVDS signal may be a reverse phase signal. The LVDS signal may be a differential signal.

The embodiments of the present disclosure disclosed in the specification and the drawings are merely presented to easily describe the technical contents of various embodiments of the present disclosure and help the understanding of them and are not intended to limit the various embodiments. Therefore, all changes or modifications derived from the technical idea of the various embodiments of the present disclosure as well as the embodiments disclosed herein should be construed to fall within the various embodiments.

What is claimed is:

1. A headphone device comprising:
a headband;
a first headphone unit connected to a first portion of the headband; and
a second headphone unit connected to a second portion of the headband and electrically connected to the first headphone unit through the headband,
wherein the first headphone unit and the second headphone unit comprise, respectively:
an interface configured to connect to a second interface of an earphone unit capable of wireless communication with a user terminal;
a low voltage differential signaling (LVDS) conversion circuit configured to:
receive, via the interface, an LVDS signal based on first data from the earphone unit, and
convert the received LVDS signal into the first data;
a digital-to-analog converter (DAC) configured to convert audio data comprised in the first data into an analog signal; and
a speaker configured to output sound based on the analog signal.

2. The headphone device of claim 1,
wherein the first headphone unit and the second headphone unit further comprise, respectively:
an earphone unit coupling portion configured to couple to the earphone unit, wherein the interface is provided in the earphone unit coupling portion; and
an earphone unit cover part configured to cover and support the earphone unit in a state in which the earphone unit coupling portion is coupled to the earphone unit via the interface.

3. The headphone device of claim 2,
wherein the earphone unit cover part comprises:
an antenna; and
an antenna contact connected to an end of the antenna,
wherein the antenna of the earphone unit cover part is configured to electrically connect, via the antenna contact, to an external contact at an end of a second antenna comprised in the earphone unit.

4. The headphone device of claim 1,
wherein the first headphone unit and the second headphone unit further comprise, respectively:
a cradle unit coupling portion in which the interface is provided and configured to couple to a cradle unit; and
a fastening hook configured to prevent the cradle unit separating from the cradle unit coupling portion.

5. The headphone device of claim 4,
wherein the cradle unit comprises:
a first surface coupled to the earphone unit;
a second surface coupled to the cradle unit coupling portion; and
a cradle unit cover part that supports the earphone unit,
wherein, when a shape of the earphone unit is different, a shape of the first surface is configured to correspond thereto, and a shape of the second surface is independent from a shape of the earphone unit.

6. The headphone device of claim 5,
wherein the cradle unit cover part comprises:
an antenna; and
an antenna contact connected to an end of the antenna,
wherein an external contact connected to an end of a second antenna of the earphone unit is configured to electrically connect to the antenna contact of the cradle unit cover part.

7. The headphone device of claim 1,
wherein the first headphone unit and the second headphone unit further comprise at least one headphone battery, and
wherein the first headphone unit and the second headphone unit are respectively configured to connect to the earphone unit via the interface and charge a battery of the earphone unit using the at least one headphone battery.

8. The headphone device of claim 1,
wherein the first data is corresponding to second data received from the user terminal through wireless communication and third data obtained by a plurality of sensors comprised in the earphone unit.

9. The headphone device of claim 7,
wherein the LVDS conversion circuit is configured to receive the LVDS signal from the earphone unit through a bidirectional channel comprising a first line and a second line.

10. The headphone device of claim 9,
wherein the LVDS signal is a differential signal and is transmitted through the first line and the second line.

11. The headphone device of claim 10,
wherein the first headphone unit and the second headphone unit further comprise, respectively:
a capacitor configured to only pass the LVDS signal; and
an LC filter configured to separate the LVDS signal and power that the at least one headphone battery transmits or receives.

12. The headphone device of claim 1,
wherein, in a state in which only one of the first headphone unit or the second headphone unit is coupled to the earphone unit,
the one of the first headphone unit or the second headphone unit that is coupled to the earphone unit is configured to transmit a portion of a received LVDS signal through the headband to the other of the first headphone unit or the second headphone unit that is not coupled to the earphone unit, and
the portion of the received LVDS signal comprises data configured to output sound by the other of the first headphone unit or the second headphone unit.

13. The headphone device of claim 1,
wherein the first headphone unit and the second headphone unit further comprise, respectively:
a plurality of sensors;
a plurality of microphones; and
at least one processor configured to:
integrate data obtained by the plurality of sensors and the plurality of microphones with the LVDS signal received from the earphone unit, and
process the data and the received LVDS signal.

14. Wireless earphones comprising:
a first earphone unit configured to couple to a first headphone unit connected to a first portion of a headband of a headphone device; and
a second earphone unit configured to couple to a second headphone unit connected to a second portion of the headband that is electrically connected to the first headphone unit,
wherein the first earphone unit and the second earphone unit comprise, respectively:
a battery;
an antenna configured to wirelessly receive second data from a user terminal;
a processor configured to generate first data based on the second data received from the user terminal;
an interface configured to connect to the headphone unit of the headphone device; and
a low voltage differential signaling (LVDS) conversion circuit configured to convert the first data into an LVDS signal via the interface, and transmit the converted LVDS signal to the headphone unit of the headphone device.

15. A method of operating a headphone device comprising:
determining whether a first headphone unit connected to a first portion of a headband and a second headphone unit connected to a second portion of the headband are connected to an earphone unit capable of wireless communication with a user terminal via an interface;
receiving, by a low voltage differential signaling (LVDS) conversion circuit respectively included in the first headphone unit and the second headphone unit, an LVDS signal based on first data received from the earphone unit;
converting the received LVDS signal into the first data by the LVDS conversion circuit;
converting audio data included in the first data into an analog signal by a digital-to-analog converter (DAC); and
outputting sound, based on the analog signal, by a speaker.
